(19) United States
(12) Patent Application Publication
(10) Pub. No.: US 2025/0223207 A1
(43) Pub. Date: Jul. 10, 2025

(54) COMPOSITIONS OF SUPPORTED METAL CATALYSTS AND METHODS THEREOF

(71) Applicant: THE TEXAS A&M UNIVERSITY SYSTEM, College Station, TX (US)

(72) Inventors: Xingmao MA, College Station, TX (US); Virender K. SHARMA, College Station, TX (US)

(21) Appl. No.: 19/013,627

(22) Filed: Jan. 8, 2025

Related U.S. Application Data
(60) Provisional application No. 63/618,528, filed on Jan. 8, 2024.

(51) Int. Cl. C02F 1/72; B01J 20/20; B01J 21/18; B01J 23/06; B01J 37/04; B01J 37/06; B01J 37/08; C02F 1/28; C02F 101/36; C02F 101/38; C02F 103/34

(52) U.S. Cl. CPC C02F 1/725; B01J 20/20; B01J 21/18; B01J 23/06; B01J 37/04; B01J 37/06; B01J 37/088; C02F 1/283; C02F 2101/36; C02F 2101/38; C02F 2103/343

(57) ABSTRACT

The present disclosure relates to supported metal catalysts, such as biochar-supported atomically dispersed metal catalysts, and methods of using supported metal catalysts to remove contaminants, such as antibiotics and per- and polyfluoroalkyl substances (PFAS), from aqueous medium.

### CROSS-REFERENCE TO RELATED APPLICATIONS

This application claims the benefit under 35 U.S.C. § 119 (e) of U.S. Provisional Application Ser. No. 63/618,528, filed on Jan. 8, 2024, the entire disclosure of which is incorporated herein by reference.

### GOVERNMENT RIGHTS

This invention was made with government support under the contract 012TAM0085H awarded by Texas Hazardous Waste Research Center (THWRC) and W912HZ-23-2-0008 award by US Army Engineering Research and Development Center, and by Geological Survey via a Fellowship program. The government has certain rights in the invention.

### BACKGROUND

Recent decades have witnessed extensive progresses in the use of metal-based nanocatalysts for contaminant removal from water. However, metal nanoparticle aggregation and possible metal ion leaching hindered their broad applications. The emergence of single-atom catalysts (SACs) introduced a new class of materials that contain atomically dispersed metal sites and display remarkable performance in contaminant degradation due to their maximum metal utilization efficiency and excellent stability and selectivity. The catalytic degradation of organic contaminants by SACs is generally achieved via the activation of peroxymonosulfate or peroxydisulfate. However, they are relatively expensive and unstable at high temperature or under light irradiation. In addition, their activation is only effective in the pH range of 2.0-8.0. Studies have also explored light irradiation to strengthen the catalytic activity of SACs. However, light-mediated process requires a strong light source and adds cost and complexity. Direct catalytic degradation of environmental contaminants by SACs without any extra oxidant or energy input is much needed.

Recently, the pervasiveness of antibiotics and the development of antibiotic resistance in water have caused serious concerns. Trimethoprim (TMP) is a frequently detected antibiotics in natural water bodies with a reported concentration up to 0.48 mg/L. One study showed that only 22.5% of orally taken TMP is metabolized in human bodies and typical wastewater treatment plants remove less than 10% of TMP, resulting in an average concentration of 2 mg/L of TMP in wastewater effluents.

Per- and polyfluoroalkyl substances (PFAS) are a group of over 10,000 man-made organo-fluorine compounds that have been used in more than 200 categories of products from 64 industries since 1940, including textiles, paper products, fire-fighting foams, cosmetics, and cookware. PFAS is extremely stable and is rapidly accumulating in the environment, especially the aquatic environment. A recent survey of several large water supplies in the U.S. serving 16.5 million people showed that more than 6.5 million of the surveyed population are exposed to water containing high PFAS. Nationally, about a third of the U.S. population is exposed to dangerous levels of PFAS. With the recognition of its widespread prevalence, and strong immunotoxicity and carcinogenicity, USEPA has enacted an enforceable drinking water standard for six most hazardous PFAS compounds, with the maximum contaminant level (MCL) set at 4 ng/L for perfluorooctanoic acid (PFOA) and perfluoro octane sulfonic acid (PFOS) and 10 ng/L for perfluorohexane sulfonate (PFHxS), perfluorononanoic acid (PFNA) and hexafluoropropylene oxide-dimer acid (HFPO-DA) (commonly known as GenX by its brand name). Although perfluorobutane sulfonic acid (PFBS) was not individually regulated, the mixture of PFBS with any of the three compounds (PFNA, HFPO-DA, and PFBS) must have a maximum allowable combined hazardous index of 1.0. This regulation has prompted a need for cost-effective PFAS removal technologies from water.

Biochar produced from waste biomass can be a promising support material for SACs because of its high specific surface area, tunable surface properties, excellent electrical conductivity, and low cost. Numerous oxygen functional groups on biochar can potentially function as an electron reservoir to replace external sources and make SACs on biochar alone an effective approach to remove contaminants. Furthermore, biochar produced at high temperatures (T>800° C.) contains abundant defects that provide ideal anchoring sites for single-atom metals.

Transition metals are commonly used in SACs, however, they are rare in the earth's crust and are expensive. Zinc (Zn) is the fourth most produced metal in the world. N-doped carbon-supported Zn SAC was reported to have an excellent performance on CO₂ reduction. It also has a more stable electronic structure because of the completely filled d orbital, leading to an excellent performance in harsh environments. However, the potential of Zn SAC in environmental remediation is rarely explored.

Many methods, such as sonolysis, cold plasma-based technologies, and thermal treatment, require high energy consumption and harsh reaction conditions, difficult to recycle and generate highly mobile short-chain PFAS metabolites. Even though advanced reduction by hydrated electrons started gaining popularity in PFAS treatment, its applicability to natural water with abundant hydrated electron quenchers, such as dissolved oxygen (DO), nitrate, and carbonates, is low. Recently, sulfate radicals (SO₄^{·-})-based advanced oxidation processes (AOP) with a heterogenous catalytic system have been emerging as a promising effective PFAS removal technique. Notably, single atom metal catalysts (SAMC) that incorporate single metal atoms into a supporting material have gained tremendous attention, and their use in PFAS degradation as an efficient activator of ^{·-} precursors is growing. The electrocatalytic activity of SAMC derives from the change of the electric density distribution in the local coordination environment of single metal atoms and the atoms of supporting materials. This effect depends on the nature of the metal ions, such as their radius size and the valence state, and the coordination structure of the metal and supporting materials. Understandably, the modified electronic structure will have a marked impact on the overall PFAS removal efficiency by SAMCs in ^{·-} based systems, especially the initial step of PFAS removal or the adsorption of PFAS and SO₄^{·-} precursors, due to the involvement of electrostatic forces. Hence, it is pivotal to understand how these changes affect the adsorption of PFAS and SO₄^{·-} precursors and the subsequent degradation at the molecular level. As the catalyst community continues to innovate in the synthesis of SAMC (e.g., by creating dual metal single atom catalysts or incorporating small atom clusters into SAMCs), this molecular-level understanding becomes even more urgent.

Therefore, there is an unmet need for the discovery and development of methods of removing contaminants, such as TMP and PFAS, using single atom metal catalysts.

### SUMMARY

In one aspect, the disclosure relates to a method of removing a contaminant from an aqueous medium. For example, the method comprises contacting a contaminant with a single-atom metal catalyst on a carbonaceous support.

In another aspect, the present disclosure relates to a method of preparing a single-atom zinc catalyst on a carbonaceous support, the method comprising: combining a carbonaceous support source, dicyandiamide, and a metal salt in an aqueous solution to provide a mixture; and pyrolyzing the mixture to provide the single-atom catalyst on the carbonaceous support.

Additional embodiments, features, and advantages of the disclosure will be apparent from the following detailed description and through practice of the disclosure.

### BRIEF DESCRIPTION OF THE DRAWINGS

FIG. 1 shows a graph of TMP removal by SAZn@BC (single-atom zinc catalyst on biochar support) with different Zn wt %. Reaction conditions: [TMP₀]=10.0 μM, [Biochar]=0.2 g/L, [pH]=4.3, T=25.0° C.

FIG. 2 shows a single catalyst model of SAZn@BC for DFT calculation.

FIG. 3A shows X-ray diffraction (XRD) patterns of SAZn@BC, and Standard ZnO. FIG. 3B shows XPS spectra of N 1s of SAZn@BC. FIG. 3C shows XPS spectra of C 1s of SAZn@BC. FIG. 3D shows XPS spectra O 1s of SAZn@BC. FIG. 3E shows high-angle annular dark field transmission electron microscopy (HAADF-TEM) images of SAZn@BC. Red circles mark the location of zinc single atoms. FIG. 3F shows elemental mapping images of the SAZn@BC for C in the highlighted red box region of FIG. 3E. FIG. 3G shows elemental mapping images of the SAZn@BC for N in the highlighted red box region of FIG. 3E. FIG. 3H shows elemental mapping images of the SAZn@BC for Zn in the highlighted red box region of FIG. 3E. FIG. 3I shows elemental mapping images of the SAZn@BC for O in the highlighted red box region of FIG. 3E. FIG. 3J shows normalized Zn K-edge XANES spectrum of SAZn@BC, Zn foil, and ZnO. FIG. 3K shows Fourier transformed EXAFS of SAZn@BC and Zn foil. FIG. 3L shows EXAFS fitting with a Zn—N₄ model.

FIG. 4A shows a graph of removal efficiency of TMP by SAZn@BC at different dosages (BC as control). FIG. 4B shows a graph of the degradation of TMP by SAZn@BC with different quenchers. FIG. 4C shows a graph of TOC removal by SAZn@BC and BC in normal or deoxygenated water. Reaction conditions for FIGS. 4A-4C: Running time=10 hours, [TMP₀]=10 μM, [Biochar]=0.2 g/L, [L-his]=10.0 μM, [MeOH]=0.5 M, [SOD]=50.0 U·ml⁻¹, [pH]=4.3, T=25.0° C.

FIG. 5 shows an illustrative schematic of plausible degradation products and degradation pathways of TMP by SAZn@BC.

FIG. 6 shows a graph of the effect of Do level on the performance of TMP removal by SAZn@BC. Reaction conditions: [TMP]=10 μM, [Biochar]=0.2 g/L, [pH]=4.5, T=25° C.

FIG. 7 shows a graph of detection of superoxide radical in SAZn@BC system. Reaction condition: [Biochar]=0.5 g/L, [NBT]₀=10 μM.

FIG. 8 shows illustrative reaction schemes of proposed reactions for the reactive species generation by the SAZn@BC.

FIG. 9 shows a graph of detection of H₂O₂ in SAZn@BC system. Reaction condition: [Biochar]=0.5 g/L, [NH₄VO₃]₀=0.2 mM. H₂O₂ reference has a concentration of 0.2 mM.

FIGS. 10A-10F show graphs of chronoamperometry I-t curves of catalyst suspension. FIG. 10A shows deoxygenated water with SAZn@BC after the addition of different volumes of oxygen-saturated water. FIG. 10B shows deoxygenated water with BC after the addition of different volumes of oxygen-saturated water. FIG. 10C shows typical deionized water with SAZn@BC after the addition of different concentrations of TMP. FIG. 10D shows typical deionized water with BC after the addition of different concentrations of TMP. FIG. 10E shows open circuit potential measurements of SAZn@BC after the addition of TMP. FIG. 10F shows Nyquist plots of electrochemical impedance spectra.

FIG. 11 shows a schematic illustration of the TMP degradation pathways by SAZn@BC.

FIG. 12 shows a graph of binding free energy between SAC, O₂, OOH and H₂O₂ (H₂Q for hydroquinone state and Q for quinone state).

FIG. 13 shows a graph of trimethoprim (TMP) removal by SAZn@BC in the presence of different inorganic anions in the solution. Reaction conditions: Running time=10 hours, [TMP₀]=10 μM, [Biochar]=0.2 g/L, [CO₃²⁻]=50 mM, [PO₄³⁻]=50 mM, [Cl⁻]=50 mM, [Br]=50 mM. pH=6.0, T=25.0° C.

FIG. 14A shows a graph of trimethoprim (TMP) degradation by SAZn@BC regenerated at different reheating temperatures after first cycle of reaction. FIG. 14B shows a graph of TMP degradation by SAZn@BC regenerated at different reheating temperatures after second cycle of reaction.

FIGS. 15A and 15B show graphs of XPS spectra of SAZn@BC before and after the reaction with TMP. The spectra of SAZn@BC before the reaction are at the top and after the reaction are at the bottom in each panel. FIG. 15A shows a graph of The O 1s spectrum. FIG. 15B shows a graph of the C 1s spectrum.

FIG. 16 shows a graph of TMP removal efficiencies by 0.10 g/L and 0.25 g/L of Zn SAC. Reaction conditions: [TMP]ₒ=10.0 M, [Zn SACs]=0.10 g/L and 0.25 g/L, mixing speed=300 rpm, pH=6.0, and Temperature=25° C.

FIG. 17 shows a graph of determination of pH_{zpc} of Zn SAC by the acid-base titration method.

FIG. 18 shows a graph of TMP removal efficiencies by Zn SAC at pH 4.0, 6.0, and 8.0. Reaction conditions: [TMP]ₒ=10.0 μM, [Zn SACs]=0.25 g/L, mixing speed=300 rpm, and Temperature=25° C.

FIG. 19 shows an illustrative schematic of possible degradation pathways and metabolites of TMP by Zn SACs in 30 min.

FIGS. 20A and 20B show graphs of the comparison of the peak area of each metabolite at pH 4.0, 6.0, and 8.0. FIG. 20A shows the LC/MS-measured peak areas of degradation products by demethylation/hydroxylation and demethylation/oxidation reactions. FIG. 20B shows the LC/MS-measured peak areas of degradation products by cleavage.

FIG. 21 shows a graph of TMP removal efficiencies by Zn SACs with the presence of anions. Reaction conditions: retention time=30 min, [TMP]ₒ=10.0 μM, [Zn SACs]=0.25 g/L, [Cl⁻]═[Br⁻]═[CO₃²⁻]═[SO₄²⁻]═[PO₄³⁻]=50 mM, mixing speed=300 rpm, pH=6.0 and Temperature=25° C.

FIG. 22A shows an image of ESP mapping of anionic PFBA. FIG. 22B shows an image of ESP mapping of anionic PFOA. FIG. 22C shows an image of ESP mapping of anionic PFOS. Green to red color in FIGS. 22A-22C represents charge being from neutral to negative.

FIG. 23A shows an image of ESP mapping of a pristine biochar modelled with 14-ring graphine layer. FIG. 23B shows an image of ESP mapping of a biochar layer with 4-pyridinic nitrogen. FIG. 23C shows an image of ESP mapping of a biochar layer with single atom Zn in the coordination of Zn—N4 structure where Zn is in +2 charge state. Colors ranging from red to green to blue in FIGS. 23A-23C indicates the change of negative to neutral to positive charge.

FIG. 24 shows a schematic illustration of the PFAS degradation process in a sulfate radical-based system with a single atom metal catalyst.

FIG. 25A shows a graph of adsorption isotherms of PFOA on three different biochar products containing different single atom metal ions. FIG. 25B shows a graph of adsorption isotherms of PFOS on three different biochar products containing different single atom metal ions.

FIG. 25C shows a graph of adsorption isotherms of PFBA on three different biochar products containing different single atom metal ions.

FIG. 26 shows a graph of the ratio of PFAS at any time vs. the initial PFAS concentration after exposure to different biochar products.

FIGS. 27A and 27B show graphs of PFOA removal efficiencies by Fe/Zn DACs. FIG. 27A shows a graph of the comparison of the removal efficiencies of PFOA by biochar without metal (BC) and Fe/Zn co-doped biochar (Fe/Zn BC). FIG. 27B shows a graph of the removal efficiencies of PFOA by 0.25 g/L Fe/Zn DACs with peroxymonosulfate (PMS), peroxydisulfate (PDS), and ethanol. Reaction conditions for FIGS. 27A and 27B: retention time=30 min, [PFOA]ₒ=100 ppb, [Fe/Zn DACs]=0.25 g/L, [PMS]=[PDS]=[Ethanol]=0.50 mM, mixing speed=300 rpm, pH=6.0, and Temperature=25° C.

FIG. 28 shows a graph of PFOA removal efficiencies by various concentrations of Fe/Zn DACs. Reaction conditions: retention time=30 min, [PFOA]ₒ=100 ppb, [Fe/Zn DACs]=0.10, 0.20 and 0.25 g/L, [PMS]=0.50 mM, mixing speed=300 rpm, pH=6.0, and Temperature=25° C.

FIG. 29A shows an image of ESP mapping of geometrically optimized molecular system with anionic PFBA on biochar supported single atom zinc catalyst (SAZnCs) containing Zn—N4 coordinated with 4 pyridinic Ns. −32.46 kcal/mol is the calculated interaction energy of the system. FIG. 29B shows an image of ESP mapping of geometrically optimized molecular system with anionic PFBA on biochar supported SAZnCs containing Zn—N4 coordinated with 2 pyridinic Ns and 2 pyrrolic Ns. −25.86 kcal/mol is the calculated interaction energy of the system. FIG. 29C shows an image of ESP mapping of geometrically optimized molecular system with anionic PFBA on biochar supported SAZnCs containing Zn—N4 coordinated with 4 pyrrolic Ns. +101.47 kcal/mol is the calculated interaction energy of the system. Blue, green and red in FIGS. 29A-29C represents positive, neutral, and negative charges following the same code as in FIGS. 23A-23C.

FIG. 30 shows a graph of interaction energies of anionic PFBA and PFOA adsorbed to SAZnC and SAFeC supported biochar with Zn²⁺ (orange) and Fe²⁺ (blue) metal atoms.

FIG. 31A shows an image of ESP mapping of geometrically optimized biochar surface with 4 pyridinic Ns. FIG. 31B shows an image of ESP mapping of geometrically optimized biochar surface with 2 pyridinic Ns and 2 pyrrolic Ns. FIG. 31C shows an image of ESP mapping of geometrically optimized biochar surface with 4 pyrrolic Ns. Blue, green and red in FIGS. 31A-31C represents positive, neutral, and negative charges following the same code as in FIGS. 23A-23C.

### DETAILED DESCRIPTION

Before the present disclosure is further described, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended clauses.

For the sake of brevity, the disclosures of the publications cited in this specification, including patents, are herein incorporated by reference. Unless defined otherwise, all technical and scientific terms used herein have the same meaning as is commonly understood by one of ordinary skill in the art to which this disclosure belongs. All patents, applications, published applications and other publications referred to herein are incorporated by reference in their entireties. If a definition set forth in this section is contrary to or otherwise inconsistent with a definition set forth in a patent, application, or other publication that is herein incorporated by reference, the definition set forth in this section prevails over the definition incorporated herein by reference.

As used herein and in the appended clauses, the singular forms “a,” “an,” and “the” include plural referents unless the context clearly dictates otherwise. It is further noted that the clauses may be drafted to exclude any optional element. As such, this statement is intended to serve as antecedent basis for use of such exclusive terminology as “solely,” “only” and the like in connection with the recitation of clause elements, or use of a “negative” limitation.

As used herein, the terms “including,” “containing,” and “comprising” are used in their open, non-limiting sense.

To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. Whenever a yield is given as a percentage, such yield refers to a mass of the entity for which the yield is given with respect to the maximum amount of the same entity that could be obtained under the particular stoichiometric conditions. Concentrations that are given as percentages refer to mass ratios, unless indicated differently.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described. All publications mentioned herein are incorporated herein by reference to disclose and describe the methods and/or materials in connection with which the publications are cited.

Except as otherwise noted, the methods and techniques of the present embodiments are generally performed according to conventional methods well known in the art and as described in various general and more specific references that are cited and discussed throughout the present specification. See, e.g., Loudon, Organic Chemistry, Fourth Edition, New York: Oxford University Press, 2002, pp. 360-361, 1084-1085; Smith and March, March's Advanced Organic Chemistry: Reactions, Mechanisms, and Structure, Fifth Edition, Wiley-Interscience, 2001.

Chemical nomenclature for compounds described herein has generally been derived using the commercially-available ACD/Name 2014 (ACD/Labs) or ChemBioDraw Ultra 13.0 (Perkin Elmer).

As used herein and in connection with chemical structures depicting the various embodiments described herein, “*”, “**”, and “ [symbol] ”, each represent a point of covalent attachment of the chemical group or chemical structure in which the identifier is shown to an adjacent chemical group or chemical structure. For example, in a hypothetical chemical structure A-B, where A and B are joined by a covalent bond, in some embodiments, the portion of A-B defined by the group or chemical structure A can be represented by “A-*”, “A-**”, or

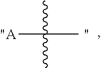

where each of “-*”, “-**”, and

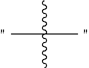

represents a bond to A and the point of covalent bond attachment to B. Alternatively, in some embodiments, the portion of A-B defined by the group or chemical structure B can be represented by “*-B”, “**-B”, or

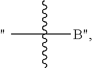

where each of “-*”, “-**”, and

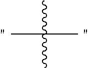

represents a bond to B and the point of covalent bond attachment to A.

As used herein and in connection with chemical structures depicting the various embodiments described herein “ [symbol] ” represents a σ-bond with an optional π-bond either not present, in the case of “-”, or present, in the case of “ [symbol] ”. It will be appreciated that the “ [symbol] ” symbol can be used in the context of a chain of atoms or a cyclic group. It will be understood that a

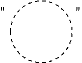

used in connection with a cyclic structure indicates that the bonds between the atoms within which the

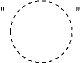

symbol is located can be either “-” or “ [symbol] ” bonds, and the

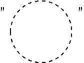

represents the delocalized electrons of π-bonds within the ring structure. In particular, a 6-membered heteroaryl described by the structure

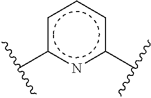

can be depicted by the structure

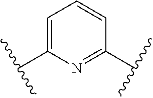 [SMILES: *c1cccc(*)n1]

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination. All combinations of the embodiments pertaining to the chemical groups represented by the variables are specifically embraced by the present disclosure and are disclosed herein just as if each and every combination was individually and explicitly disclosed, to the extent that such combinations embrace compounds that are stable compounds (i.e., compounds that can be isolated, characterized, and tested for biological activity). In addition, all subcombinations of the chemical groups listed in the embodiments describing such variables are also specifically embraced by the present disclosure and are disclosed herein just as if each and every such subcombination of chemical groups was individually and explicitly disclosed herein.

### Definitions

Unless otherwise defined herein, scientific and technical terms used in this application shall have the meanings that are commonly understood by those of ordinary skill in the art. Generally, nomenclature used in connection with, and techniques of, chemistry, inorganic chemistry, analytical chemistry, catalysis, metal catalysis, and crystallography, described herein, are those well-known and commonly used in the art.

The methods and techniques of the present disclosure are generally performed, unless otherwise indicated, according to conventional methods well known in the art and as described in various general and more specific references that are cited and discussed throughout this specification. See, e.g. “Principles of Neural Science”, McGraw-Hill Medical, New York, N.Y. (2000); Motulsky, “Intuitive Biostatistics”, Oxford University Press, Inc. (1995); Lodish et al., “Molecular Cell Biology, 4th ed.”, W. H. Freeman & Co., New York (2000); Griffiths et al., “Introduction to Genetic Analysis, 7th ed.”, W. H. Freeman & Co., N.Y. (1999); and Gilbert et al., “Developmental Biology, 6th ed.”, Sinauer Associates, Inc., Sunderland, Mass. (2000).

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, Calif. (1985).

All of the above, and any other publications, patents and published patent applications referred to in this application are specifically incorporated by reference herein. In case of conflict, the present specification, including its specific definitions, will control.

The term “substituted” refers to moieties having substituents replacing a hydrogen on one or more carbons of the backbone. It will be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, etc. As used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. The permissible substituents can be one or more and the same or different for appropriate organic compounds. For purposes of this disclosure, the heteroatoms such as nitrogen may have hydrogen substituents and/or any permissible substituents of organic compounds described herein which satisfy the valences of the heteroatoms. Substituents can include any substituents described herein, for example, a halogen, a hydroxyl, a carbonyl (such as a carboxyl, an alkoxycarbonyl, a formyl, or an acyl), a thiocarbonyl (such as a thioester, a thioacetate, or a thioformate), an alkoxyl, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. It will be understood by those skilled in the art that the moieties substituted on the hydrocarbon chain can themselves be substituted, if appropriate.

As used herein, the terms “optional” or “optionally” mean that the subsequently described event or circumstance may occur or may not occur, and that the description includes instances where the event or circumstance occurs as well as instances in which it does not. For example, “optionally substituted alkyl” refers to the alkyl may be substituted as well as where the alkyl is not substituted.

It is understood that substituents and substitution patterns on the compounds of the present disclosure can be selected by one of ordinary skilled person in the art to result chemically stable compounds which can be readily synthesized by techniques known in the art, as well as those methods set forth below, from readily available starting materials. If a substituent is itself substituted with more than one group, it is understood that these multiple groups may be on the same carbon or on different carbons, so long as a stable structure results.

As used herein, the term “optionally substituted” refers to the replacement of one to six hydrogen radicals/atoms in a given structure with a specified substituent including, but not limited to: deuterium, hydroxyl, hydroxyalkyl, alkoxy, halogen, alkyl, alkenyl, alkynyl, nitro, silyl, acyl, acyloxy, aryl, cycloalkyl, heterocyclyl, amino, aminoalkyl, cyano, haloalkyl, haloalkoxy, haloalkenyl, haloalkynyl, ketone or oxo, carboxy, amide, ester, OCOCH₂O-alkyl, OP(O)(O-alkyl)₂, or CH₂OP(O)(O-alkyl)₂. Preferably, “optionally substituted” refers to the replacement of one to four hydrogen radicals in a given structure with the substituents mentioned above. More preferably, one to three hydrogen radicals are replaced by the substituents as mentioned above. It is understood that the substituent can be further substituted.

As used herein, the term “alkyl” refers to saturated aliphatic groups, including but not limited to C₁-C₁₀ straight-chain alkyl groups or C₁-C₁₀ branched-chain alkyl groups. Preferably, the “alkyl” group refers to C₁-C₆ straight-chain alkyl groups or C₁-C₆ branched-chain alkyl groups. Most preferably, the “alkyl” group refers to C₁-C₄ straight-chain alkyl groups or C₁-C₄ branched-chain alkyl groups. Examples of “alkyl” include, but are not limited to, methyl, ethyl, 1-propyl, 2-propyl, n-butyl, sec-butyl, tert-butyl, 1-pentyl, 2-pentyl, 3-pentyl, neo-pentyl, 1-hexyl, 2-hexyl, 3-hexyl, 1-heptyl, 2-heptyl, 3-heptyl, 4-heptyl, 1-octyl, 2-octyl, 3-octyl or 4-octyl and the like. The “alkyl” group may be optionally substituted.

The term “acyl” is art-recognized and refers to a group represented by the general formula hydrocarbylC(O)—, preferably alkylC(O)—.

The term “alkoxy” refers to an alkyl group having an oxygen attached thereto. Representative alkoxy groups include methoxy, ethoxy, propoxy, tert-butoxy and the like.

The term “C_{x-y}” or “Cₓ-C_{y}”, when used in conjunction with a chemical moiety, such as, acyl, alkyl, alkenyl, alkynyl, or alkoxy is meant to include groups that contain from x to y carbons in the chain. Cₒ alkyl indicates a hydrogen where the group is in a terminal position, a bond if internal. A C₁₋₆ alkyl group, for example, contains from one to six carbon atoms in the chain.

The term “amide”, as used herein, refers to a group

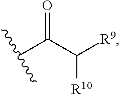

wherein R⁹ and R¹⁰ each independently represent a hydrogen or hydrocarbyl group, or R9 and R10 taken together with the N atom to which they are attached complete a heterocycle having from 4 to 8 atoms in the ring structure.

The terms “amine” and “amino” are art-recognized and refer to both unsubstituted and substituted amines and salts thereof, e.g., a moiety that can be represented by

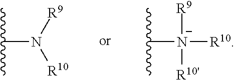

wherein R⁹, R¹⁰, and R^{10′}, each independently represent a hydrogen or a hydrocarbyl group, or R⁹ and R¹⁰ taken together with the N atom to which they are attached complete a heterocycle having from 4 to 8 atoms in the ring structure.

The term “aryl” as used herein include substituted or unsubstituted single-ring aromatic groups in which each atom of the ring is carbon. Preferably the ring is a 5- to 7-membered ring, more preferably a 6-membered ring. The term “aryl” also includes polycyclic ring systems having two or more cyclic rings in which two or more carbons are common to two adjoining rings wherein at least one of the rings is aromatic, e.g., the other cyclic rings can be cycloalkyls, cycloalkenyls, cycloalkynyls, aryls, heteroaryls, and/or heterocyclyls. Aryl groups include benzene, naphthalene, phenanthrene, phenol, aniline, and the like.

The term “carbocycle” includes 5-7 membered monocyclic and 8-12 membered bicyclic rings. Each ring of a bicyclic carbocycle may be selected from saturated, unsaturated and aromatic rings. Carbocycle includes bicyclic molecules in which one, two or three or more atoms are shared between the two rings. The term “fused carbocycle” refers to a bicyclic carbocycle in which each of the rings shares two adjacent atoms with the other ring. Each ring of a fused carbocycle may be selected from saturated, unsaturated and aromatic rings. In an exemplary embodiment, an aromatic ring, e.g., phenyl, may be fused to a saturated or unsaturated ring, e.g., cyclohexane, cyclopentane, or cyclohexene. Any combination of saturated, unsaturated and aromatic bicyclic rings, as valence permits, is included in the definition of carbocyclic. Exemplary “carbocycles” include cyclopentane, cyclohexane, bicyclo[2.2.1]heptane, 1,5-cyclooctadiene, 1,2,3,4-tetrahydronaphthalene, bicyclo[4.2.0]oct-3-ene, naphthalene and adamantane. Exemplary fused carbocycles include decalin, naphthalene, 1,2,3,4-tetrahydronaphthalene, bicyclo[4.2.0]octane, 4,5,6,7-tetrahydro-1H-indene and bicyclo[4.1.0]hept-3-ene. “Carbocycles” may be substituted at any one or more positions capable of bearing a hydrogen atom.

The term “carboxy”, as used herein, refers to a group represented by the formula —CO₂H.

The term “cycloalkyl” refers to a saturated or partially saturated, monocyclic or polycyclic mono-valent carbocycle. The term “cycloalkylene” refers to a saturated or partially saturated, monocyclic or polycyclic di-valent carbocycle. In some embodiments, it can be advantageous to limit the number of atoms in a “cycloalkyl” or “cycloalkylene” to a specific range of atoms, such as having 3 to 12 ring atoms. Polycyclic carbocycles include fused, bridged, and spiro polycyclic systems. It will be appreciated that a cycloalkyl or cycloalkylene group can be unsubstituted or substituted as described herein. A cycloalkyl or cycloalkylene group can be substituted with any of the substituents in the various embodiments described herein, including one or more of such substituents.

The term “ester”, as used herein, refers to a group —C(O) OR⁸ wherein R⁸ represents a hydrocarbyl group.

The term “ketone”, as used herein, refers to a group —C(O)R⁷ wherein R⁷ represents a hydrocarbyl group (e.g., alkyl, aryl, heteroaryl).

The term “ether”, as used herein, refers to a hydrocarbyl group linked through an oxygen to another hydrocarbyl group. Accordingly, an ether substituent of a hydrocarbyl group may be hydrocarbyl-O—. Ethers may be either symmetrical or unsymmetrical. Examples of ethers include, but are not limited to, heterocycle-O-heterocycle and aryl-O-heterocycle. Ethers include “alkoxyalkyl” groups, which may be represented by the general formula alkyl-O-alkyl.

The term “oxo” as used herein refers to a carbon-oxygen double bond (C═O).

The terms “halo” and “halogen” as used herein means halogen and includes chloro, fluoro, bromo, and iodo.

The terms “hetaralkyl” and “heteroaralkyl”, as used herein, refers to an alkyl group substituted with a hetaryl group.

The terms “heteroaryl” and “hetaryl” include substituted or unsubstituted aromatic single ring structures, preferably 5- to 7-membered rings, more preferably 5- to 6-membered rings, whose ring structures include at least one heteroatom, preferably one to four heteroatoms, more preferably one or two heteroatoms. The terms “heteroaryl” and “hetaryl” also include polycyclic ring systems having two or more cyclic rings in which two or more carbons are common to two adjoining rings wherein at least one of the rings is heteroaromatic, e.g., the other cyclic rings can be cycloalkyls, cycloalkenyls, cycloalkynyls, aryls, heteroaryls, and/or heterocyclyls. Heteroaryl groups include, for example, pyrone, benzopyrone (e.g., chromone), pyrrole, benzopyrrole, furan, benzofuran, thiophene, imidazole, oxazole, thiazole, indole, pyrazole, pyridine, pyrazine, pyridazine, and pyrimidine, and the like.

The term “heteroatom” as used herein means an atom of any element other than carbon or hydrogen. Preferred heteroatoms are nitrogen, oxygen, sulfur, and phosphorus.

The terms “heterocyclyl”, “heterocycle”, and “heterocyclic” refer to substituted or unsubstituted non-aromatic ring structures, preferably 3- to 10-membered rings, more preferably 3- to 7-membered rings, whose ring structures include at least one heteroatom, preferably one to four heteroatoms, more preferably one or two heteroatoms. The terms “heterocyclyl” and “heterocyclic” also include polycyclic ring systems having two or more cyclic rings in which two or more carbons are common to two adjoining rings wherein at least one of the rings is heterocyclic, e.g., the other cyclic rings can be cycloalkyls, cycloalkenyls, cycloalkynyls, aryls, heteroaryls, and/or heterocyclyls. Heterocyclyl groups include, for example, benzopyran (chromene), benzodihydropyran (chromane), dihydrobenzodioxine (benzodioxan), dihydrobenzofuran, benzodioxole, piperidine, piperazine, pyrrolidine, morpholine, lactones, lactams, and the like.

The term “hydrocarbyl”, as used herein, refers to a group that is bonded through a carbon atom that does not have a ═O or ═S substituent, and typically has at least one carbon-hydrogen bond and a primarily carbon backbone, but may optionally include heteroatoms. Thus, groups like methyl, ethoxyethyl, 2-pyridyl, and even trifluoromethyl are considered to be hydrocarbyl for the purposes of this application, but substituents such as acetyl (which has a ═O substituent on the linking carbon) and ethoxy (which is linked through oxygen, not carbon) are not. Hydrocarbyl groups include, but are not limited to aryl, heteroaryl, carbocycle, heterocycle, alkyl, alkenyl, alkynyl, and combinations thereof.

The term “lower” when used in conjunction with a chemical moiety, such as, acyl, acyloxy, alkyl, alkenyl, alkynyl, or alkoxy is meant to include groups where there are ten or fewer atoms in the substituent, preferably six or fewer. A “lower alkyl”, for example, refers to an alkyl group that contains ten or fewer carbon atoms, preferably six or fewer. In certain embodiments, acyl, acyloxy, alkyl, alkenyl, alkynyl, or alkoxy substituents defined herein are respectively lower acyl, lower acyloxy, lower alkyl, lower alkenyl, lower alkynyl, or lower alkoxy, whether they appear alone or in combination with other substituents, such as in the recitations hydroxyalkyl and aralkyl (in which case, for example, the atoms within the aryl group are not counted when counting the carbon atoms in the alkyl substituent).

The terms “polycyclyl”, “polycycle”, and “polycyclic” refer to two or more rings (e.g., cycloalkyls, cycloalkenyls, cycloalkynyls, aryls, heteroaryls, and/or heterocyclyls) in which two or more atoms are common to two adjoining rings, e.g., the rings are “fused rings”. Each of the rings of the polycycle can be substituted or unsubstituted. In certain embodiments, each ring of the polycycle contains from 3 to 10 atoms in the ring, preferably from 5 to 7.

The terms “aromatic” and “aromatic compounds” as used herein refers to chemical compounds that consist of conjugated planar ring systems accompanied by delocalized pi-electron clouds in place of individual alternating double and single bonds. Aromatic compounds require satisfying Huckel's rule. Huckel's rule states that planar, fully conjugated monocyclic polyenes having 4n+2π electrons, where n is an integer, that is, n=0, 1, 2, 3, 4, etc., possess aromatic stability. An aromatic compound contains sp² hybridized carbon atoms and obeys the Huckel rule. In heterocyclic aromatic compounds, at least one carbon atom is replaced by one of the heteroatoms oxygen, nitrogen, or sulfur. Examples of heterocyclic aromatic compounds are furan, pyrrole, and pyridine.

The term “transition metal” (or transition element) refers to a chemical element in the d-block of the periodic table (groups 3 to 12). Preferred transition metals include zinc (Zn), copper (Cu), iron (Fe), cobalt (Co), nickel (Ni), palladium (Pd), and aluminum (Al).

The term “PFAS” refers to per- and polyfluoroalkyl substances. Examples of PFAS include perfluorooctanoic carboxylic acid (PFOA), perfluorooctanoic sulfonic acid (PFOS), perfluorobutanoic carboxylic acid (PFBA), perfluorononanoic acid (PFNA), perfluorobutane sulfonate (PFBS), perfluorohexanesulfonic acid (PFHxS), and hexafluoropropylene oxide dimer acid (HFPO-DA).

The term “carbonaceous support” refers to materials such as carbon nanotubes (CNTs), graphene, activated carbon (AC), and biochar. In some embodiments, metal catalysts may be deposited on carbonaceous support to provide a metal catalyst on support.

The term “biochar” refers to a stable solid, rich in carbon, that is made from organic waste material or biomass that is partially combusted in the presence of limited oxygen. Organic waste material can include wood powder/chips, agricultural byproducts, switchgrass, timber slash, corn stalks, manure, and the like. The qualities that make up biochar vary depending upon the material that it comes from (feedstocks) and the temperature at which combustion occurs. The various materials and methods to produce biochar result in a wide variety of chemical and physical properties across biochar products. Biochar may be provided from either artificial or natural origin.

The terms “oxidant” or “oxidizing agent” refer to a substance in a redox chemical reaction that gains an electron from a reducing agent (reductant, reducer, or electron donor). Examples of oxidants include, hydrogen peroxide, persulfate, peroxymonosulfate (PMS), and peroxydisulfate (PDS). In some embodiments, an oxidant may be highly reactive and may generate a radical.

### REPRESENTATIVE EMBODIMENTS

In some embodiments, the present disclosure relates to a method of removing a contaminant from an aqueous medium comprising contacting a contaminant with a metal catalyst. In some embodiments, the metal catalyst is on a carbonaceous support.

In some embodiments, the metal catalyst on carbonaceous support comprises about 0.01 wt % to about 5 wt % metal. For example, the metal catalyst on carbonaceous support may comprise about 0.1 wt % to about 5 wt % metal, 0.1 wt % to about 3 wt % metal, 0.1 wt % to about 2 wt % metal, 1 wt % to about 5 wt % metal, 1 wt % to about 3 wt % metal, or 1 wt % to about 2 wt % metal.

In some embodiments, the metal catalyst on carbonaceous support is a single-atom metal catalyst. In some embodiments, the single-atom metal catalyst comprises a transition metal atom. The transition metal atom (M) may be selected from the group consisting of zinc, copper, iron, cobalt, nickel, palladium, aluminum, and any combination thereof. In some embodiments, the metal atom in the metal catalyst has an oxidation state of +1, +2, +3, +4, or a combination thereof.

In some embodiments, the metal catalyst comprises a single atom zinc catalyst, a single atom copper catalyst, a single atom iron catalyst, a single atom cobalt catalyst, a single atom nickel catalyst, a single atom palladium catalyst, a single atom aluminum catalyst, or any combination thereof.

In some embodiments, the single-atom metal catalyst is a dual metal single atom catalyst (DAC) comprising two transition metal atoms selected from the group consisting of zinc, copper, iron, cobalt, nickel, palladium, and aluminum. In some embodiments, the metal catalyst is a dual metal single atom catalyst (DAC) comprising a molar ratio of two metal atoms. For example, the dual metal single atom catalyst (DAC) may comprise a molar ratio of about 1:1 to about 1:25, about 1:1 to about 1:10, about 1:1 to about 1:5, or about 1:1 to about 1:2 of a first metal atom to a second metal atom.

In some embodiments, the metal catalyst on carbonaceous support comprises an atomic cluster of about 2 to about 10 metal atoms selected from the group consisting of zinc, copper, iron, cobalt, nickel, palladium, aluminum, and any combination thereof.

In some embodiments, the carbonaceous support is carbon nanotubes (CNTs), graphene, activated carbon (AC), biochar, or any combination thereof. In some embodiments, the carbonaceous support is activated carbon (AC) or biochar.

In some embodiments, the metal atom of the single-atom metal catalyst on carbonaceous support is coordinated to about 2 to about 5 heteroatoms (e.g., nitrogen, oxygen, sulfur, or phosphorus) of the carbonaceous support. In some embodiments, the metal atom of the single-atom metal catalyst on carbonaceous support is coordinated to about 4 nitrogen atoms (M-N₄) of the carbonaceous support.

In some embodiments, the metal atom of the single-atom metal catalyst on carbonaceous support is undersaturated or oversaturated. For example, an undersaturated metal atom may be coordinated to a fewer number of heteroatoms than a stable metal atom, and an oversaturated metal atom may be coordinated to a greater number of heteroatoms than a stable metal atom.

In some embodiments, the single atom metal catalyst on carbonaceous support comprises the structure of Formula I:

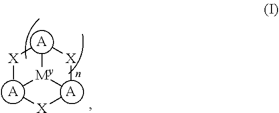

wherein
M is a metal atom;
y is an oxidation state of +1, +2, +3, or +4;
each ring A is independently a heteroaryl (e.g., pyrrole or pyridine);
each X is independently a bond or a linker comprising one or more sp² atoms; and
n is 0, 1, 2, or 3.

In some embodiments, the single atom metal catalyst on carbonaceous support comprises the structure of Formula II:

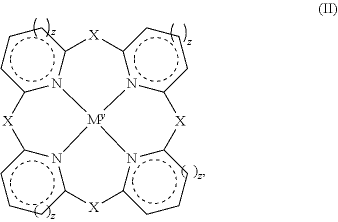

wherein
M is a metal atom;
y is an oxidation state of +1, +2, +3, or +4;
each X is independently a bond or a linker comprising one or more sp² atoms; and
each z is independently 0 or 1.

In some embodiments, each ring A is independently a 5- or 6-membered heteroaryl. In some embodiments, each ring A is independently a pyrrole or pyridine.

In some embodiments, the single atom metal catalyst on carbonaceous support comprises two or more structures of Formula I. For example, the single atom metal catalyst on carbonaceous support may comprise a first structure of Formula I, wherein M is a first metal atom, and a second structure of Formula I, wherein M is a second metal atom.

In some embodiments, M is selected from the group consisting of zinc, copper, iron, cobalt, nickel, palladium, aluminum, and any combination thereof.

In some embodiments, y is +1, +2, +3, or +4. In some embodiments, y is a combination of +1, +2, +3, or +4. In one example, M may be iron with an oxidation state of +2 and +3. In another example, M may be zinc with an oxidation state of +2.

In some embodiments, each X is independently a bond or a linker comprising one or more sp² carbon atoms. In some embodiments, each X is independently a bond, or a linker comprising one or more sp² atoms, wherein the linker comprises a portion selected from the group consisting of

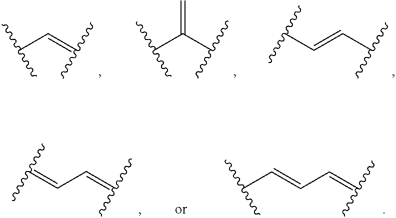

In some embodiments, the aqueous medium is natural water, surface water, groundwater, or wastewater.

In some embodiments, the aqueous medium has a pH of about 2 to about 12. For example, the pH of the aqueous medium may be about 2 to about 10, about 3 to about 10, about 4 to about 10, about 5 to about 10, about 6 to about 10, about 7 to about 10, or about 8 to about 10.

In some embodiments, the method comprises adding the metal catalyst (e.g., single-atom catalyst) on carbonaceous support to an aqueous medium at a concentration of about 0.01 g/L to about 10 g/L. For example, the metal catalyst on carbonaceous support may be added to the aqueous medium at a concentration of about 0.01 g/L to about 5 g/L, about 0.01 g/L to about 3 g/L, about 0.01 g/L to about 2 g/L, about 0.01 g/L to about 1 g/L, about 0.1 g/L to about 5 g/L, about 0.1 g/L to about 3 g/L, about 0.1 g/L to about 2 g/L, or about 0.1 g/L to about 1 g/L.

In some embodiments, the aqueous medium comprises dissolved organic matter (DOM), cations, anions, or any combination thereof. The DOM may comprise fulvic acid (FA), humic acid (HA), and natural organic matter (NOM). The cations may comprise sodium, calcium, magnesium, iron, manganese, or any combination thereof. The anions may comprise chloride (Cl⁻), bromide (Br⁻), carbonate (CO₃²⁻), sulfate (SO₄²⁻), phosphate (PO₄³⁻), or any combination thereof.

In some embodiments, the method comprises adding an oxidant (e.g., an oxidant precursor) to the aqueous medium. In some embodiments, the method comprises adding a metal catalyst (e.g., single-atom catalyst) on carbonaceous support and an oxidant (e.g., an oxidant precursor) to an aqueous medium. The oxidant may be added prior to, at the same time as, or after the metal catalyst (e.g., single-atom catalyst) on carbonaceous support is added to the aqueous medium. For example, the oxidant may be added to the aqueous medium at a concentration of about 0.01 mM to about 10 mM, about 0.01 mM to about 5 mM, about 0.01 mM to about 3 mM, about 0.01 mM to about 2 mM, about 0.01 mM to about 1 mM, about 0.1 mM to about 10 mM, about 0.1 mM to about 5 mM, about 0.1 mM to about 3 mM, about 0.1 mM to about 2 mM, or about 0.1 mM to about 1 mM.

In some embodiments, the method comprises contacting the contaminant with a metal catalyst and an oxidant (e.g., an oxidant radical). In some embodiments, the method comprises contacting a metal catalyst on carbonaceous support with an oxidant precursor, thereby providing an oxidant radical, and contacting the contaminant with the oxidant radical.

In some embodiments, sulfate radical (SO₄^{·-}) precursors, such as peroxymonosulfate (PMS) and peroxydisulfate (PDS), may be adsorbed to the active sites of the single atom metal catalyst on carbonaceous support first, the sulfate radical (SO₄^{·-}) precursors may be activated to generate reactive radicals, and the reactive radicals oxidize the adsorbed contaminant (e.g., PFAS).

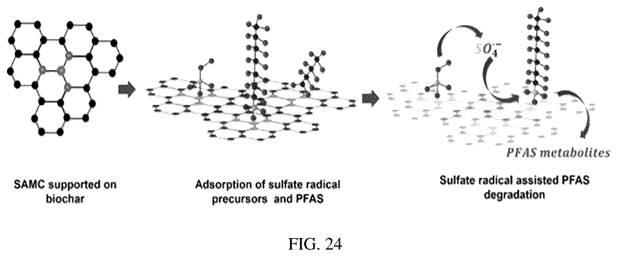

In some embodiments, the contaminant (e.g., PFAS) may be oxidized on the same sites of the single atom metal catalyst as the radical precursors, as shown in FIG. 24.

In some embodiments, the oxidant is an oxidant precursor selected from hydrogen peroxide, persulfate, peroxymonosulfate (PMS), peroxydisulfate (PMS), or any combination thereof. In some embodiments, the oxidant is peroxymonosulfate (PMS) or peroxydisulfate (PMS). In some embodiments, the oxidant is an oxidant radical derived from an oxidant precursor. For example, the oxidant may be an oxidant radical derived from peroxymonosulfate (PMS) or peroxydisulfate (PMS), such as a sulfate radical.

In some embodiments, the step of contacting the contaminant with a metal catalyst (e.g., a single-atom catalyst) on a carbonaceous support and/or an oxidant radical includes oxidizing (e.g., degrading) the contaminant, thereby removing the contaminant. In some embodiments, the oxidizing is a direct oxidation reaction, a radical oxidation reaction, or a combination thereof. For example, the oxidizing may comprise co-occurring radical reaction and direct oxidation. In some embodiments, direct oxidation comprises the electron transfer from the contaminant to the metal catalyst on carbonaceous support. In some embodiments, the electron transfer from the metal catalyst on carbonaceous support to dissolved oxygen in the aqueous medium generates H₂O₂ and ^{·}OOH, thereby contributing to the radical oxidation of the contaminant.

In some embodiments, the single-atom metal catalyst on a carbonaceous support and an oxidant (e.g., and oxidant radical) synergistically oxidizes (e.g., degrades) the contaminant.

In some embodiments, the metal catalyst on a carbonaceous support has a negative, neutral, or positive charge. In some embodiments, the metal catalyst on a carbonaceous support comprises one or more oxygen containing substituents, such as oxo or carboxy groups.

In some embodiments, the contaminant is a pharmaceutical contaminant, an environmental contaminant, or a combination thereof. In some embodiments, the contaminant is a pharmaceutical contaminant comprising an antibiotic, a hormone, an opiate, an anti-inflammatory, or any combination thereof. In some embodiments, the contaminant is an antibiotic comprising TMP. In some embodiments, the contaminant is an environmental contaminant that comprises a per- and polyfluoroalkyl substance (PFAS). A PFAS, for example may comprise perfluorooctanoic carboxylic acid (PFOA), perfluorooctanoic sulfonic acid (PFOS), perfluorobutanoic carboxylic acid (PFBA), perfluorononanoic acid (PFNA), perfluorobutane sulfonate (PFBS), perfluorohexanesulfonic acid (PFHxS), hexafluoropropylene oxide dimer acid (HFPO-DA), or any combination thereof.

In some embodiments, the present disclosure relates to a method of preparing a single-atom zinc catalyst on a carbonaceous support, the method comprising: combining a carbonaceous support source, dicyandiamide, and a metal salt in an aqueous solution to provide a mixture; and pyrolyzing the mixture to provide the single-atom catalyst on the carbonaceous support.

In some embodiments, the carbonaceous support source is an organic waste material selected from the group consisting of wood powder/chips, agricultural byproducts, switchgrass, timber slash, corn stalks, and manure.

In some embodiments, wherein the metal salt comprises a transition metal selected from the group consisting of zinc (Zn), copper (Cu), iron (Fe), cobalt (Co), nickel (Ni), palladium (Pd), and aluminum (Al), and an anion. In some embodiments, the anion is selected from the group consisting of nitrate, acetate, sulfate, chlorate, phosphate, chloride, and bromide.

In some embodiments, the single-atom metal catalyst is a dual metal single atom catalyst (DAC) comprising two transition metal atoms selected from the group consisting of zinc, copper, iron, cobalt, nickel, palladium, and aluminum. In some embodiments, the metal catalyst is a dual metal single atom catalyst (DAC) comprising a molar ratio of two metal atoms. For example, the dual metal single atom catalyst (DAC) may comprise a molar ratio of about 1:1 to about 1:25, about 1:1 to about 1:10, about 1:1 to about 1:5, or about 1:1 to about 1:2 of a first metal atom to a second metal atom.

In some embodiments, the metal salt comprises two or more metal salts. In some embodiments, the metal salt comprises a first metal salt and a second metal salt. In some embodiments, each of the first metal salt and the second metal salt independently comprise a transition metal selected from the group consisting of zinc (Zn), copper (Cu), iron (Fe), cobalt (Co), nickel (Ni), palladium (Pd), and aluminum (Al), and an anion.

In some embodiments, wherein the step of pyrolyzing comprises heating the mixture to a temperature of about 400° C. to about 1000° C. For example, the temperature may be about 600° C. to about 1000° C.

In some embodiments, wherein the step of pyrolyzing comprises heating the mixture for about 1 hour to about 12 hours. For example, the pyrolyzing may be performed for about 2 hours to about 5 hours.

In some embodiments, comprising a step of washing the single-atom zinc catalyst on a biochar support with an aqueous solution, thereby removing an impurity. In some embodiments, the impurity comprises a metal oxide, such as zinc oxide or iron oxide.

It may be advantageous to provide catalysts that maintain or improve catalytic efficiency and are environmentally friendly. The supported metal catalysts and methods defined herein, for example, may be net carbon negative, possess large adsorption capacity and strong electrocatalytic and photocatalytic property. In some embodiments, the biochar-supported metal catalyst can remove PFAS without any additional material or energy input. An advantage of the biochar-supported metal catalyst is its low energy demand because of its electrocatalytic property. It can generate highly reductive hydrated electrons due to the strain of the metal-C—N coordinates. The biochar also provides a large specific surface for adsorption and it is a net carbon negative material. Therefore, applying biochar-supported atomically dispersed metal catalyst will not only remove PFAS to achieve a cleaner environment, but also contribute to environmental sustainability and mitigate the impact of global climate change.

In some embodiments, the biochar-supported metal catalyst can be used as a powder catalyst in surface water or groundwater treatment processes. In another embodiment, the biochar-supported metal catalyst may be used as filter media in a filtration process.

In some embodiments, the electrocatalytic performance of the catalyst can be attributed to the coordination between redox active functional groups and metal (e.g., zinc) single-atom sites.

The cost-effectiveness of SAZnC on biochar support and its simple regeneration makes this material alone a highly effective and sustainable material in environmental remediation. Notably, tremendous amounts of natural biomass contain transitional heavy metals, and the disposal of this biomass has been a main environmental challenge. The materials and methods of the present disclosure offer an appealing approach to upcycle the metal-bearing biomass by converting them into effective metal catalysts on the carbon support.

In some embodiments, the sulfate radical (SO₄^{·-}) in a heterogenous catalytic system is more effective than those in the bulk solution in contaminant removal. For example, surface-bound radicals might be the main contributing factor for effective PFAS degradation in single atom metal catalyst (SAMC) systems.

In some embodiments, PFAS degradation occurs on the surface of SAMC. For example, adsorption may be a key governing factor of the removal efficiency. Hence, understanding the fundamental processes of PFAS and PMS/PDS adsorption to SAMC, such as their adsorption sites, adsorption energy, orientation, potential adsorbate/adsorbate and adsorbate/adsorbent interactions, and adsorption kinetics and capacity is critical. In the present disclosure, a synergistic approach combining experimental investigation, mathematical modeling, and a multiscale computational framework, incorporating both Density Functional theory (DFT) and Molecular Dynamics (MD) are employed to uncover the fundamental mechanisms of PFAS adsorption on single atom metal catalysts.

By varying feedstock sources and pyrolysis conditions (e.g., temperature and duration), the properties of biochar, such as its porosity, specific surface area, oxygen functional groups, and electron shuttling properties can be modified. In SAMC, metal sites may function as the primary active sites for contaminant adsorption and degradation, and the properties of these active sites may be affected by the interaction of metal atoms with surrounding supporting material atoms and the local coordination environment. Recently, efforts have been made to replace expensive noble metals with more common transitional metals, such as iron, to reduce the cost of SAMCs.

In some embodiments, metal single atoms in SAMCs create high-energy adsorption sites for PFAS and PMS/PDS because the Lewis acidity of metal ions, particularly high-valent metal ions, enhances the affinity of organic compounds for the adsorbent by altering the electron density of coordinated ligands. In some embodiments, the extent of enhancement for PFAS adsorption is dependent on the metal's properties (e.g., atomic radius and valence charge), its configuration (e.g., single atoms vs. atomic clusters), the local coordination environment and the type of PFAS compounds.

Various embodiments of the invention are provided throughout the present disclosure. It will be understood that any of the embodiments described herein can be used in connection with any other embodiments described herein to the extent that the embodiments do not contradict one another. Compositions and methods of the present disclosure include those described in the following numbered embodiments, which are contemplated and non-limiting.
1. A method of removing a contaminant from an aqueous medium, the method comprising contacting a contaminant with a single-atom metal catalyst on a carbonaceous support.
2. The method of clause 1, any other suitable clause, or any combination of suitable clauses, wherein the carbonaceous support is activated carbon or biochar.
3. The method of clause 1, any other suitable clause, or any combination of suitable clauses, wherein the single-atom catalyst comprises a metal atom (M) selected from the group consisting of zinc (Zn), copper (Cu), iron (Fe), cobalt (Co), nickel (Ni), palladium (Pd), aluminum (Al), and any combination thereof.
4. The method of clause 3, any other suitable clause, or any combination of suitable clauses, wherein the metal atom is coordinated to 2, 3, 4, or 5 heteroatoms of the carbonaceous support, and wherein each heteroatom is independently selected from the group consisting of nitrogen, oxygen, sulfur, and phosphorus.
5. The method of clause 3, any other suitable clause, or any combination of suitable clauses, wherein the single-atom catalyst on carbonaceous support comprises about 0.01 wt % to about 5 wt % metal.
6. The method of clause 1, any other suitable clause, or any combination of suitable clauses, further comprising adding the single-atom catalyst to the aqueous medium at a concentration of about 0.01 g/L to about 10 g/L.
7. The method of clause 1, any other suitable clause, or any combination of suitable clauses, further comprising contacting the contaminant, the single-atom metal catalyst, or a combination thereof with an oxidant.
8. The method of clause 1, any other suitable clause, or any combination of suitable clauses, wherein the step of contacting comprises oxidizing the contaminant.
9. The method of clause 8, any other suitable clause, or any combination of suitable clauses, wherein the oxidizing is a direct oxidation reaction, a radical oxidation reaction, or a combination thereof.
10. The method of clause 1, any other suitable clause, or any combination of suitable clauses, wherein the contaminant is a pharmaceutical contaminant, an environmental contaminant, or a combination thereof.
11. The method of clause 10, any other suitable clause, or any combination of suitable clauses, wherein the contaminant is a pharmaceutical contaminant comprising an antibiotic, a hormone, an opiate, an anti-inflammatory, or any combination thereof.
12. The method of clause 10, any other suitable clause, or any combination of suitable clauses, wherein the contaminant is an environmental contaminant that comprises a per- and polyfluoroalkyl substance (PFAS).
13. A method of preparing a single-atom zinc catalyst on a carbonaceous support, the method comprising:
combining a carbonaceous support source, dicyandiamide, and a metal salt in an aqueous solution to provide a mixture; and
pyrolyzing the mixture to provide the single-atom catalyst on the carbonaceous support.
14. The method of clause 13, any other suitable clause, or any combination of suitable clauses, wherein the carbonaceous support is activated carbon, biochar, or a combination thereof.
15. The method of clause 14, any other suitable clause, or any combination of suitable clauses, wherein the metal salt comprises a metal selected from the group consisting of zinc (Zn), copper (Cu), iron (Fe), cobalt (Co), nickel (Ni), palladium (Pd), and aluminum (Al), and an anion.
16. The method of clause 15, any other suitable clause, or any combination of suitable clauses, wherein the anion is selected from the group consisting of nitrate, acetate, sulfate, chlorate, phosphate, chloride, and bromide.
17. The method of clause 13, any other suitable clause, or any combination of suitable clauses, wherein the single-atom catalyst on carbonaceous support comprises about 0.01 wt % to about 5 wt % metal.
18. The method of clause 13, any other suitable clause, or any combination of suitable clauses, wherein the step of pyrolyzing comprises heating the mixture to a temperature of about 400° C. to about 1000° C.
19. The method of clause 13, any other suitable clause, or any combination of suitable clauses, further comprising a step of washing the single-atom zinc catalyst on a biochar support with an aqueous solution, thereby removing an impurity.
20. The method of clause 19, any other suitable clause, or any combination of suitable clauses, wherein the impurity comprises a metal oxide.
21. A single-atom zinc catalyst on a carbonaceous support prepared by the method of any one of clauses 13 to 20.

### EXAMPLES

### Example 1A

### Materials and Methods for TMP Degradation

### Materials

Post oak pellet was obtained from B&B Charcoal (Weimar, USA). Trimethoprim (TMP, ≥ 98.0%) and sulfamethoxazole (SMX, ≥98.0%) were purchased from TCI America (Portland, USA). 5,5-dimethyl-1-pyrroline N-oxide (DMPO, ≥98.0%), hydrogen peroxide (H₂O₂, 30%) and hydrochloric acid (HCl, 33-38%) were obtained from Fisher Chemical (Waltham, USA). 2,2,6,6-tetramethyl-4-piperidinol (TEMPO, 99%) and ammonium metavanadate (NH₄VO₃, 99.5%) were purchased from ACROS Organics (Waltham, USA). L-histidine (L-his, ≥98.0%), nitro blue tetrazolium (NBT, ≥98.0%) and dicyandiamide (98.0%) were purchased from Alfa Aesar (Haverhill, USA). The following chemicals were purchased from different suppliers: methanol (MeOH, reagent grade) from VWR Chemicals (Radnor, USA), acetonitrile (CH3CN, ≥99.7%) from BTC (Hudson, USA), superoxide dismutase (SOD, 6010 U/mg) from Millipore Sigma (Burlington, USA), and zinc nitrate (Zn (NO₃)₂, ≥98.5%) from Spectrum Chemical (New Brunswick, USA). All chemicals were used as received. Industrial-grade nitrogen used in the experiment was purchased from Airgas (Radnor, USA). All solutions were prepared using ultrapure water produced by a NANOpure II filter from Thermo Fisher Scientific (Waltham, USA).

### Synthesis of Single-Atom Zn Catalyst on Biochar Support (SAZn@BC)

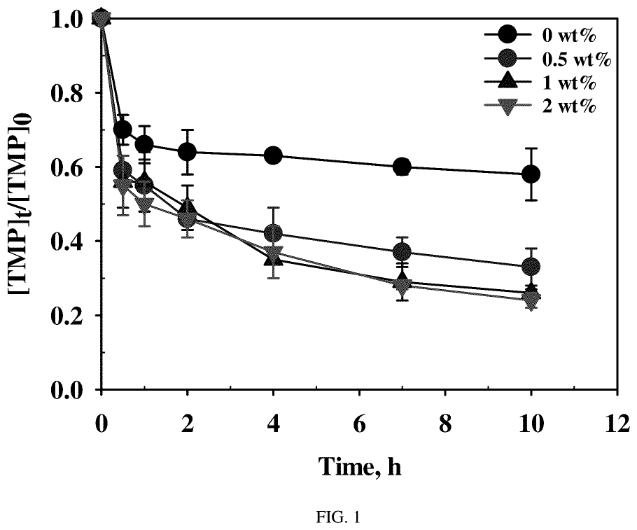

Oak wood powders ground from wood pellets in a mortar was used as the biochar feedstock. For synthesizing the biochar, 10.0 g of wood powder, 5.0 g of dicyandiamide, and 0.29 g of zinc nitrate (resulting in about 1 wt % Zn by weight in the final product) were mixed with 150 mL of ultrapure water at 500 rpm and 90° C. for one hour. 1 wt % Zn loading rate was chosen based on preliminary data, FIG. 1. The mixture was then dried in an oven at 85° C. for 20 hours before pyrolysis. The pyrolysis was carried out in a box furnace (Fisher Scientific, USA) for three hours with a continuous flow of nitrogen gas. The peak temperature was set at 800° C., with a heating rate of 5° C./minute. The product was ground into fine powders in a mortar and was acid washed with 100 mL of 2.0 M HCl with a stirring speed of 400 rpm for 2.0 hours at 90° C. on a magnetic stirrer. The product was then collected by vacuum filtration through a 0.45 μm membrane and washed with 2.0 L ultrapure water. The collected SAZn@BC was air-dried in a hood for 12 hours and ground with a pestle and mortar into small powders before their storage. SAZn@BC with 0 wt % Zn loading was also prepared with same method and was named as BC. The final product had a particle size ranging from 0.5 μm to 8.7 μm, with an average size of about 2.8 μm. The most dominant sizes were less than 3 μm.

### Characterization of Single-Atom Zn Catalyst on Biochar

The crystal structure of SAZn@BC was determined using X-ray diffraction (XRD, Bruker-AXS D8, Billerica, USA) with an X-ray source produced by a 2.0 kW Cu X-ray tube (λ=1.5418 Å). The XRD was operated at 40 kV and 25 mA. The morphology of the catalyst was determined by transmission electron microscopy (TEM, Titan Themis 300 S/TEM, Hillsboro, USA) at 300 kV. A high-angle annular dark field (HAADF) detector was applied to identify single Zn atoms, and a Super-X EDS detector was used to map the distribution of C, N, O, and Zn elements on SAZn@BC. X-ray photoelectron spectroscopy (XPS) analysis in a Phi 560 ESCA/SAM system (PerkinElmer, Waltham, MA, USA) was conducted to determine the oxygen-containing functional groups. Survey scans were performed in the 0-1,200 eV range in 0.2 eV steps, while high-resolution XPS spectra for C, N, O, and Zn were acquired in 0.1 eV steps. X-ray absorption spectroscopy (XAS) was used to confirm the single-atom state of Zn and the local coordination structure. The XAS spectra were measured in transmission at the Materials Research Collaborative Access Team (MRCAT) Sector 10 bending magnet beamline at Argonne National Laboratory's Advanced Photon Source using a double crystal detuned, water-cooled Si (111) monochromator in continuous scan mode. The data were processed and fitted using the IFEFFIT-based Athena and Artemis software packages.

### Degradation of Trimethoprim (TMP)

The initial concertation of TMP was 10.0 μM, and the initial concentration of SAZn@BC was 0.20˜0.4 g/L. The study was carried out in 50.0 mL plastic tubes covered with aluminum foil and mixed on a shaker table at 300 rpm and 25° C. One mL sample was withdrawn from each tube at different time intervals (t=0, 0.5, 1.0, 2.0, 4.0, 7.0, 10.0 hours) and was immediately filtered with a 0.45 μm syringe filter. The concentration of TMP was measured by Dionex UltiMate 3000 high-performance liquid chromatography (HPLC) (Sunnyvale, USA). The total organic carbon (TOC) before and after 10 hours of TMP degradation was measured by Shimadzu TOC Analyzer in systems containing SAZn@BC. The impact of dissolved oxygen on TMP degradation was investigated by purging the mixture with purified N2 gas for 0, 2, 5 and 10 minutes before TMP degradation, resulting in an oxygen level of 1.86-7.52 mg/L in different reactors.

### Degradation Products of TMP

Samples collected at 0, 0.5, and 2.0 hours were used to identify TMP degradation products. Solid-phase extraction (SPE) was used to concentrate TMP and its metabolites in the samples. Waters Oasis HLB cartridges (WAT106202, 6 cc/200 mg) were pre-conditioned with 5.0 mL methanol and 5.0 mL ultrapure water in the SPE analysis before they were loaded with 1.0 mL samples. The cartridges were vacuum-dried for 10 minutes after loading, and the samples were eluted with 1.0 mL of methanol and stored in 2 mL microtubes. Untargeted analysis was performed with a liquid chromatography high-resolution accurate mass spectrometry (LC-HRAM) fitted with a Q Exactive Plus Orbitrap mass spectrometer (Thermo Fisher Scientific, Waltham, USA) and connected to a binary pump UltiMate 3000 HPLC (Sunnyvale, USA).

### Quenching Study

Three quenchers: 10.0 mM L-his, 0.5 M MeOH, and 50 U·mL⁻¹ SOD (superoxide dismutase) were used to quench singlet oxygen (102), hydroxyl radical (OH) and superoxide radical (O₂^{·-}), respectively. TMP degradation by SAZn@BC was also performed in heavy water (D₂O) to confirm the possible role of ¹O₂. O₂^{·-} and hydrogen peroxide (H₂O₂) were analyzed following methods summarized below.

### Superoxide Radical Detection

The presence of superoxide radical (O₂^{·-}) was determined by the reaction between O₂^{·-} and nitroblue tetrazolium chloride (NBT). Briefly, 0.5 mg SAZn@BC was added into 10 μM NBT solution (10 mL) and stirred at 400 rpm for one hour. 2 mL samples were taken at 0, 30, and 60 mins and filtered through a 0.45 μm syringe filter. NBT in the filtrate was analyzed by a UV-vis-NIR spectrophotometer (Hitachi U-4100) at 260 nm.

### Hydrogen Peroxide Detection

The generation of hydrogen peroxide (H₂O₂) was confirmed by the reaction between H₂O₂ and metavanadate to produce peroxovanadate. 0.5 mg SAZn@BC was added into 0.2 mM ammonia metavanadate solution (10 mL) and stirred at 400 rpm for 20 minutes with pH adjusted to 3.0, 5.0, and 6.0, respectively. The mixture of 0.2 mM H₂O₂ and 0.2 mM ammonia metavanadate was stirred at 400 rpm for 20 minutes as a control. The produced peroxovanadate was detected with a UV-vis-NIR spectrophotometer (Hitachi U-4100) at 450 nm.

### Electrochemical Measurement

A three-electrode system (CH Instrument) with a 3.0 mm glassy carbon electrode as the working electrode, Ag/AgCl (3.0 M KCl) as the reference electrode and graphite rod as the counter electrode was used. Electrochemical impedance spectroscopy (EIS) was performed with open circuit voltage (OCV) as the specific voltage and an AC amplitude of 5.0 mV over the frequency range from 105 Hz to 0.01 Hz. The chronoamperometry I-t curve was measured by fixing OCV. The catalytic current was monitored by adding 1.0 mL of TMP (5.0, 10.0, and 20.0 μM) or oxygen-saturated water (0.5, 1.0 and 2.0 mL) into suspensions containing 10.0 mL deoxygenated water and 5.0 mg SAZn@BC or BC, stirring at 300 rpm. In addition, the change in open circuit potential (OCP) was measured by adding 1 mL of contaminant (20 μM) solutions into SAZn@BC suspensions to determine the direct electron transfer between TMP and SAZn@BC.

### Density Functional Theory (DFT) Calculations

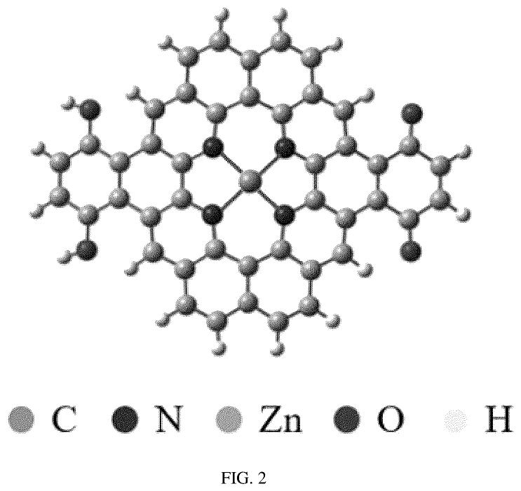

Molecular simulations were performed using DFT in Gaussian16 utilizing M06L function. The 6-31G* basis set was chosen for C, N, H, and O, while LANL2DZ was used for Zn atoms. The implicit solvent model of solvation model based on density (SMD) was employed to describe water solvation in all simulations. The initial model of SAZn@BC was built using 10 conjugated six-member rings with four center rings doped with one N each and coordinated with a zinc atom in the center, FIG. 2. Hydroquinone and quinone were attached on the side as representative oxygen functional groups in biochar support. To elucidate the role of Zn single atoms, simulations were also performed with the BC control containing 0.0 wt % of Zn. Species 02, OOH, and H₂O₂ were optimized on the surface of the catalyst as higher multiplicities were also investigated to find lower energy configuration. Frequency calculation was performed at T=298 K and P=1 atm using harmonic potential approximation after optimization of the structures. The population analysis was performed by Natural Bond Orbital (NBO) method.

### Recyclability Study

After each run, the SAZn@BC was collected with a 0.45 μm membrane filter and washed with 200 mL ultrapure water. It was then regenerated by heating at either 100° C. or 250° C. for 5.0 hours or dried at room temperature (25° C.) for 48 hours. After drying, the biochar was used directly in TMP degradation without additional treatments. The heating regeneration was repeated after the second cycle to evaluate the long-term reusability of the catalyst. In each cycle, the recovery rate was about 90% due to the incomplete recovery of SAZn@BC adsorbed on the membrane. However, this did not affect the assessment of the performance of the regenerated SAZn@BC in the study because plenty replicates were prepared so that the regenerated SAZn@BC used in each replicate was the same as the pristine SAZn@BC.

### Example 1B

### Characterizations of Single-Atom Zn Catalyst Supported on Biochar

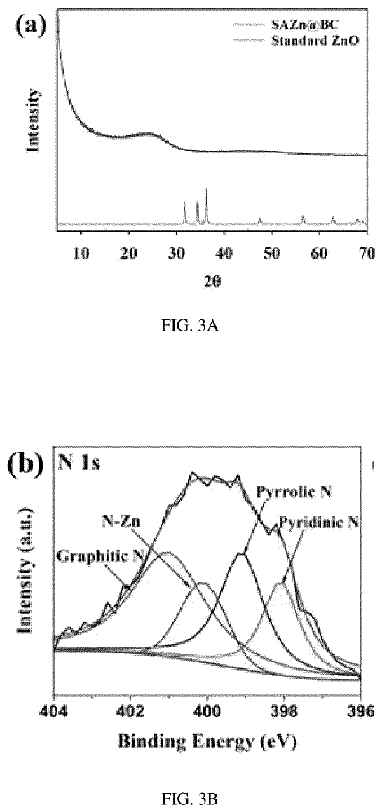

The XRD pattern of SAZn@BC, FIG. 3A had an almost flat curve indicating the successful removal of ZnO. The fitting result of N 1s spectrum of XPS analysis in FIG. 3B supports the formation of Zn—N—C bond by the Zn—N peak at 400.12 eV. The peaks at 401.06 eV, 399.11 eV, 398.02 eV are graphitic N, pyrrolic N and pyridinic N, respectively, indicating the formation of N-doped carbon. The strong peak at 284.43 eV in C 1s spectrum (FIG. 3C) indicates the dominance of aromatic carbon in SAZn@BC. Strong peaks at 286.51 eV and 288.11 eV in C 1s spectrum correspond to C—O/C—N and C═O/C═N peaks, respectively, confirmed by the peaks at 531.18 eV and 533.30 eV in the O 1s spectrum (FIG. 3D). The strong C—O peaks could be attributed to the presence of phenolic and hydroquinone groups while the intensive C═O peaks suggest the presence of quinone moiety on the catalyst.

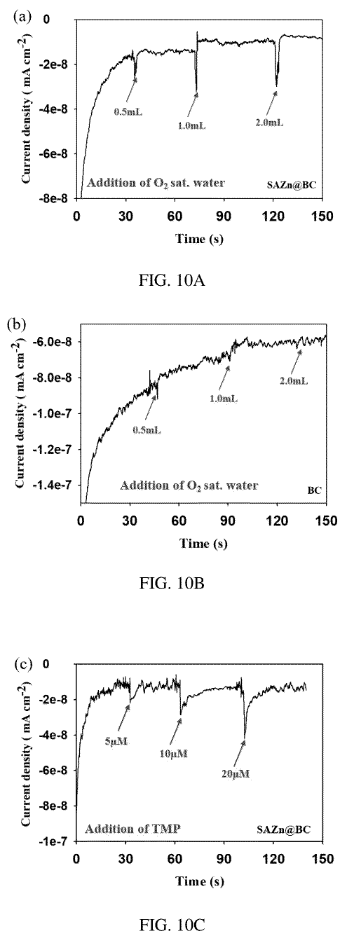

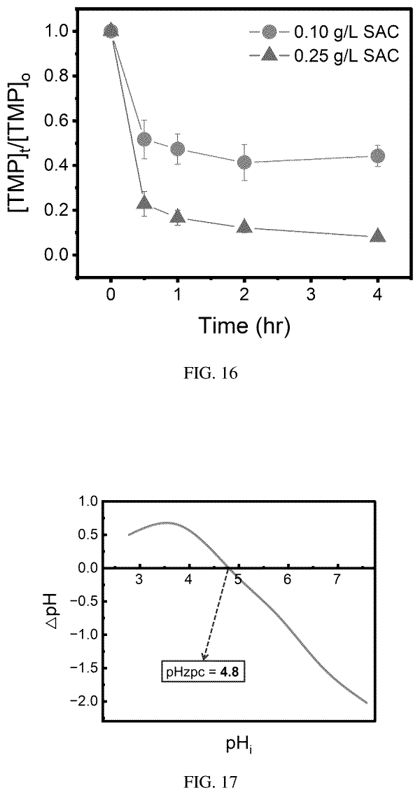

HAADF-TEM analysis was also performed (FIGS. 3E-I). The presence of Zn single-atom sites, represented by the bright dots with a diameter around 2 Å, can be clearly seen in FIG. 3E, and no aggregation was observed. The EDS mapping (FIGS. 3F-31) in the highlighted area in FIG. 3E shows the ultrafine distribution of C, N, Zn, and O atoms with a composition of 80.72, 12.18, 0.83, and 6.22 wt % in SAZn@BC, respectively. XAFS results that reveal the local coordination environment of Zn atoms in SAZn@BC agree with the TEM observation FIGS. 3J-3L. According to the normalized Zn K-edge X-ray absorption near edge structure (XANES) spectra of SAZn@BC, Zn metal, and ZnO in FIG. 3J, the valence state of Zn in SAZn@BC is +2. The EXAFS spectrum was analyzed to gain information on the coordination environment of Zn atoms on biochar. The Fourier transformed EXAFS result (FIG. 3K) shows that Zn in SAZn@BC has a prominent peak at around 1.58 Å, corresponding to the Zn—N bond. The absence of the Zn—Zn peak at 2.30 Å indicates that all Zn atoms in SAZn@BC are in single-atom form. To further reveal the local coordination structure, Fourier-transformed EXAFS data were fitted by Artemis software, which indicates that every Zn atom in SAZn@BC is linked to 4 N (Zn—N₄ structure) with a mean bond length of 2.07 Å, FIG. 3L.

### Example 1C

### Removal of TMP by Single-Atom Zn Catalyst Supported on Biochar

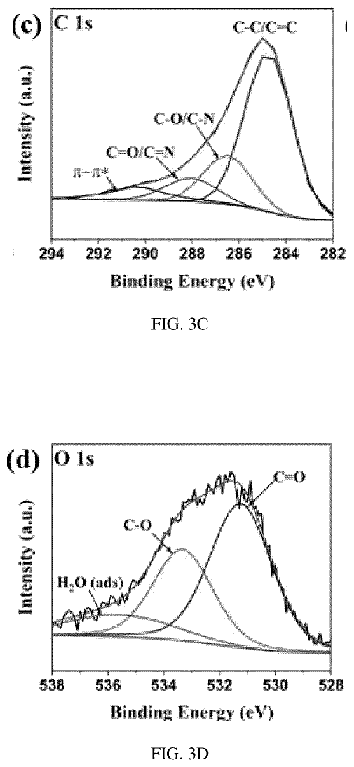

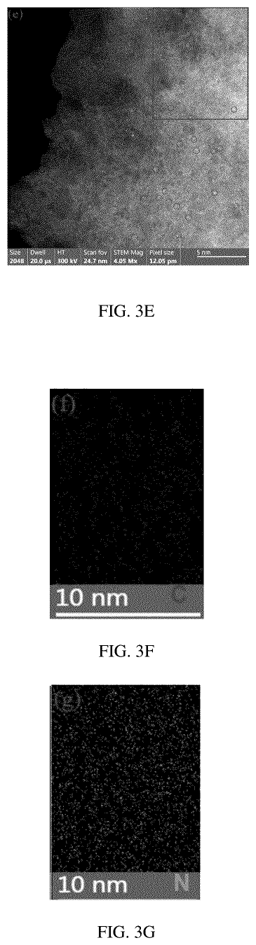

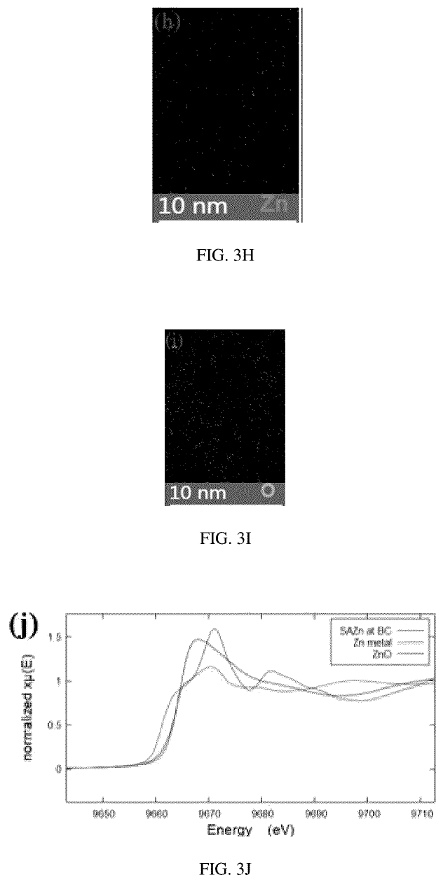

At a dosage of 0.2 g/L, single-atom Zn biochar (SAZn@BC) with 1 wt % Zn by weight removed 74.0% TMP in 10 hours without any additional chemical agents, and an increase of SAZn@BC at 0.4 g/L achieved a remarkable 98.0% removal of TMP in 30 mins (FIG. 4A). Previous studies on single-atom metal catalysts almost exclusively focused on activating peroxymonosulfate (PMS)/peroxydisulfate (PDS) in sulfate radical-based advanced oxidation processes to achieve contaminant removal, however, these data may suggest that SAZn@BC alone can result in significant contaminant removal. While adsorption might play an important role in the beginning, the enabled degradation of TMP by SAZn@BC was likely the main reason for the excellent performance of SAZn@BC, which was confirmed by the detection of various TMP metabolites from bond cleavage, demethylation and hydrolysis with an untargeted analysis, FIG. 5. In addition, the TOC measurement (FIG. 4C) also suggested the increased TOC removal from around 30% to 50% with the incorporation of single-atom Zn into the biochar. Interestingly, the performance of SAZn@BC depended heavily on the levels of dissolved oxygen (DO), FIG. 6, suggesting that DO or reactive oxygen species (ROS) might play a significant role in the degradation of TMP by SAZn@BC. The TOC study also suggested the important role of DO in the system that the TOC removal decreased from 50% to 20% after the deoxygenation.

### Example 1D

### Quenching Study and TMP Degradation by Reactive Species

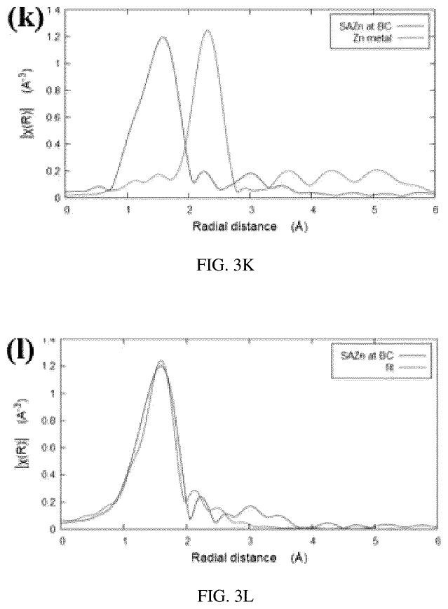

Based on the results in FIG. 4B, MeOH did not affect the degradation of TMP, suggesting that hydroxyl radical (OH) was not involved in TMP degradation by ZnSA@BC. L-histidine significantly inhibited the TMP degradation. However, replacing ultrapure water with D₂O did not lead to enhanced TMP removal, suggesting a minimal role of ¹O₂ because ¹O₂ has a longer lifetime in D₂O and would lead to a greater TMP removal if it was involved in TMP degradation After the addition of low-concentration superoxide dismutase (SOD), TMP degradation dropped from 74.0% to 41.0%. This strong inhibition implied the critical role of O₂^{·-}, and the generation was further confirmed by the NBT test (FIG. 7).

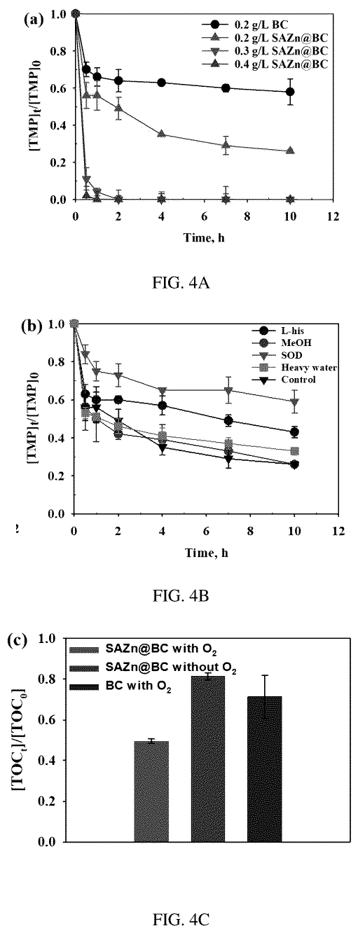

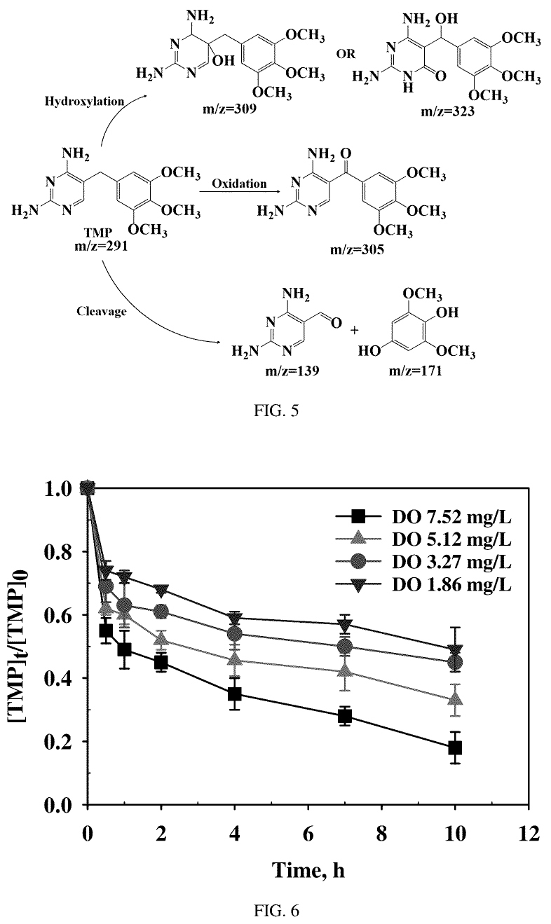

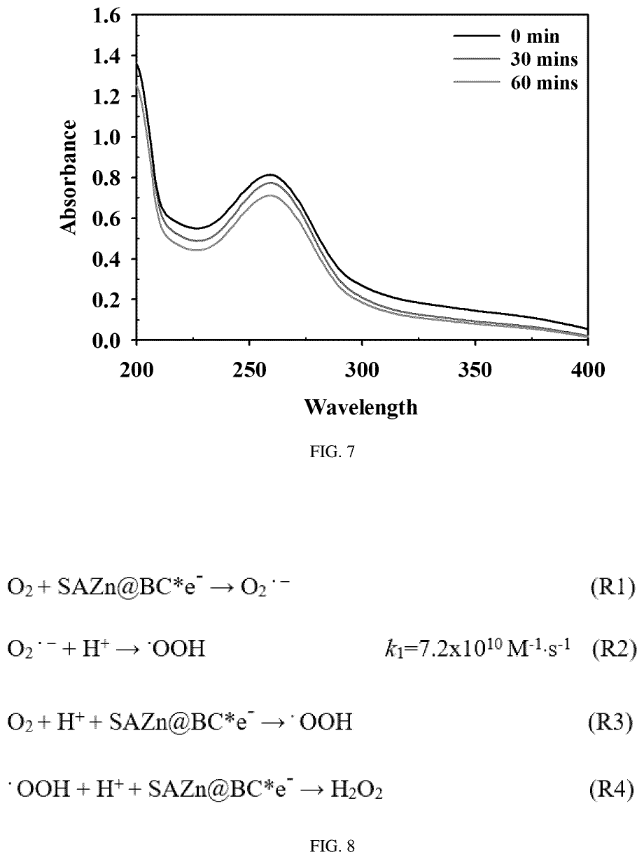

However, O₂^{·-} has a low redox potential of E⁰=−0.33 V (vs. NHE) and is unlikely to oxidize TMP (E⁰=+1.1 V (vs. NHE)). In an acidic environment (pH 4.3), the majority of O₂^{·-} is in the form of hydroperoxyl radical (OOH) (E⁰=+1.44 V (vs. NHE), pKₐ=4.88) which is a much stronger oxidant. OOH could further produce H₂O₂ (E⁰=+1.8 V (vs. NHE)), as shown in reactions R1 to R4 (FIG. 8). And reactions between H₂O₂, OOH and TMP were proposed as the main mechanisms leading to the indirect oxidation of TMP by SAZn@BC. The UV-vis measurements suggested that H₂O₂ was about 0.05 mM in the system at the time of measurement, FIG. 9. The electron transfer from SAZn@BC to DO was also confirmed by chronoamperometry I-t measurement, FIG. 10A, with the current change intensity proportional to the amount of O₂ added to the system. Importantly, such result was not found in the BC system, FIG. 10B, indicating the necessity of single-atom Zn as an electron transfer bridge to facilitate electron transfer.

### Example 1E

### Direct TMP Oxidation by Single-Atom Zn Catalyst on Biochar Support

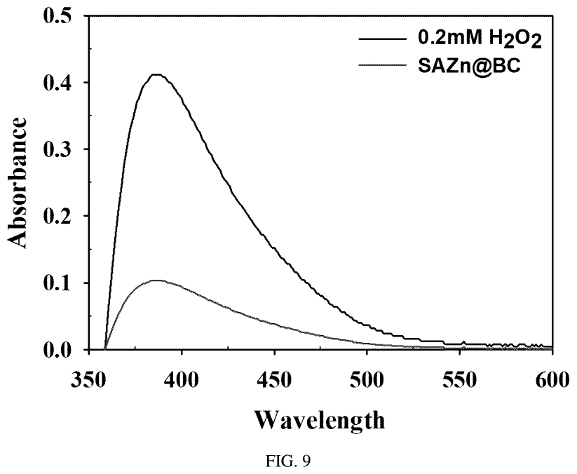

Although TMP degradation by ROS was significant (i.e., 38.0-41.0%), yet TMP in the system was still removed after SOD quenching, suggesting that additional mechanisms might be occurring. Adsorption on the biochar support material likely contributed to part of the removal of TMP from solution. Chronoamperometry measurements revealed the positive and linear correlation (R2-0.93) of the current change intensity with the concentration of TMP added to the system (FIG. 10C), confirming direct electron transfer between SAZn@BC and TMP, which was not found in BC system, FIG. 10D, again emphasizing the important role of single-atom Zn sites for the direct oxidization of TMP. The direct electron transfer was also supported by the OCP measurements, FIG. 10E, that showed a signal drop after the addition of TMP, indicating its direct oxidization. The EIS Nyquist plots, FIG. 10F, revealed different electron transfer resistance of the SAZn@BC after TMP addition, providing further support of direct electron transfer between TMP and SAZn@BC. Overall, these results demonstrate a combined radical pathway and direct oxidization for TMP degradation by SAZn@BC as illustrated in FIG. 11.

### Example 1F

### DFT Calculations

The lowest energy values of different multiplicities were employed for binding free energy calculations and the results are tabulated in FIG. 11. The negative bind-free energy indicated that O₂ and OOH can be easily adsorbed on the catalyst surface to induce reactions to generate O₂^{·-} and H₂O_{2·}⁴¹ The overall reaction potential of R1, R3, and R4 (FIG. 8) were summarized in Table 1. The calculation of free energy with respect to the biased potential was performed using the computational hydrogen electrode model. Here, the bias potential U (V) denotes the voltage applied to an electrode in an electrochemical cell relative to a reference electrode. In the model, the free energy (ΔG) was defined as eU with a unit of eV. The reactions of O₂ and ·OOH accepting electrons from SAZn@BC to generate O₂^{·-} and H₂O₂ was simulated at U=0 V, implying that no voltage was applied to the system, and the negative free energy of −1.70, −1.91 and −1.4 eV for reaction R1, R3 and R4 demonstrated that these reactions are spontaneous. DFT calculations were also performed for the catalyst without Zn, Table 2. After eliminating Zn, the free energy of R1 for the generation of O₂^{·-} turned positive (+0.48 eV), suggesting the necessity of the Zn single-atom sites for the spontaneous ROS generation. The results agree with the poor TOC removal in the reactor with BC control, FIG. 4C.

TABLE 1
Free energy of intermediates at potential relative to free
catalyst and oxygen for SAZn@BC containing Zn sites.

| Reaction | R1 | R3 | R4 |
|---|---|---|---|
| Free energy (eV) at U = 0 V | −1.70 | −1.91 | −1.40 |
| Free energy (eV) at U = 0.22 V | −1.70 | −1.69 | −0.96 |

TABLE 2
Free energy of intermediates at potential relative to
free catalyst and oxygen for SAZn@BC without Zn sites.

| Reaction | R1 | R3 |
|---|---|---|
| Free energy (eV) at U = 0 V | 0.48 | −0.85 |
| Free energy (eV) at U = 0.22 V | 0.48 | −0.62 |

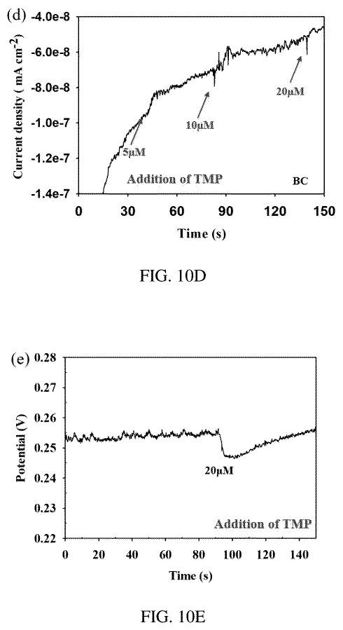

The results of NBO calculations for the catalyst indicate the direction of electron transfer between reactants and SAZn@BC, Table 3. Positive values for SAC/O₂ and SAC/OOH indicate electron transfer from the hydroqunione to O₂ and OOH. The negative values for SAC/TMP revealed the opposite electron transfer. Overall, DFT calculations supported the experimental studies that 02 and OOH are reduced while TMP is oxidized by SAZn@BC, leading to effective degradation of TMP through both pathways. A comparison of the degradation rate constant of TMP, Table 4, showed that even though SAZn@BC did not display the highest performance among all catalysts, it had much higher TMP removal efficiency than conventional photocatalysts or biochar products. However, it is important to emphasize that this study was performed in deionized water. Natural water contains a diverse group of constituents such as inorganic anions which are known to quench some reactive oxygen species and form secondary radicals. The impact of several common anions such as PO₄³⁻ and CO₃²⁻ was examined on the removal of TMP by SAZn@BC, FIG. 13. All inorganic anions inhibited the removal of TMP, with CO₃²⁻ demonstrated the greatest inhibition. These results suggest that the composition of natural water has a marked impact on the performance of SAZn@BC and additional studies are needed to gain more insights into the potential effectiveness of SAZn@BC in natural water.

TABLE 3
Partial charge from Natural Population Analysis values for catalyst

| Combination | SAC/O₂ | SAC/•OOH | SAC/TMP |
|---|---|---|---|
| Partial charge | 0.76 | 0.76 | −0.10 |

TABLE 4
Comparison of the second order rate constant of
TMP degradation in different catalyst systems

| | | | Initial TMP | Second |
|---|---|---|---|---|
| | | | concen- | rate |
| | Dosage | | tration | constant |
| Catalyst | (g L⁻¹) | System | (μM) | (L/g · min) |
| SAZn@BC | 0.2 | Catalyst only | 10 | 8.07 × 10⁻² |
| N-dopped | 1 | Persulfate | 45 | 8.7 × 10⁻³ |
| Biochar | | activation | | |
| Malt rootlet | 0.045 | Persulfate | 3.7 | 6.88 × 10⁻² |
| biochar | | activation | | |
| CO₃O₄/BiOI | 0.8 | Photocatalysis | 0.07 | 1.57 × 10⁻² |
| Co-doped | 0.01 | Photocatalysis | 10 | 1.31 |
| organic aerogels | | | | |
| Ni-doped organic | 0.01 | Photocatalysis | 10 | 1.48 |
| aerogels | | | | |
| Zn-doped organic | 0.01 | Photocatalysis | 10 | 1.24 |
| aerogels | | | | |
| Fe-doped organic | 0.01 | Photocatalysis | 10 | 1.21 |
| aerogels | | | | |
| TiO₂-P25 | 1 | Photocatalysis | 1 | 2.4 × 10⁻³ |
| Au/TiO₂-P25 | 1 | Photocatalysis | 1 | 5.2 × 10⁻³ |
| Ag/TiO₂-P25 | 1 | Photocatalysis | 1 | 5.2 × 10⁻³ |
| Cu/TiO₂-P25 | 1 | Photocatalysis | 1 | 4.5 × 10⁻³ |
| Ni/TiO₂-P25 | 1 | Photocatalysis | 1 | 3.0 × 10⁻³ |

### Example 1G

### Reusability

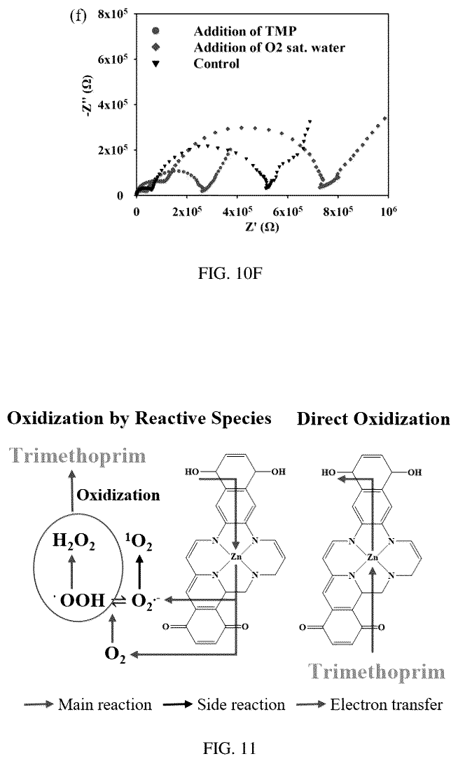

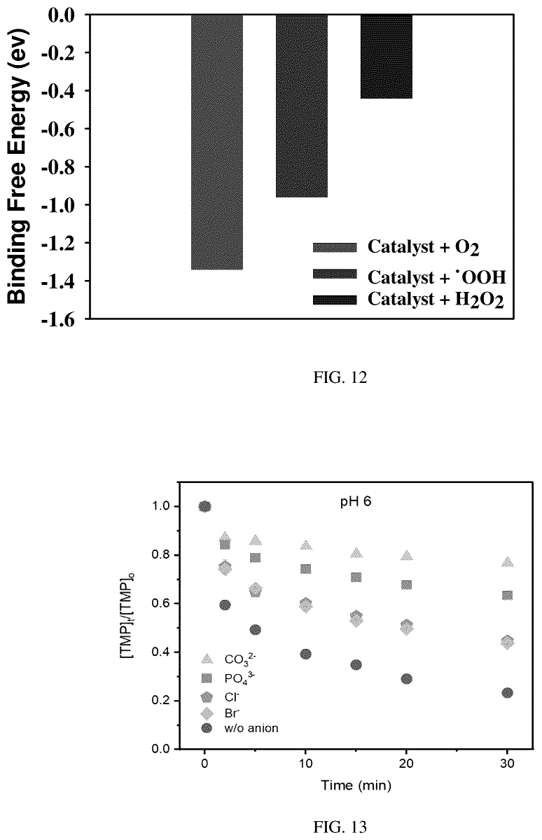

The reusability of a catalyst is an important consideration in sustainable applications of catalysts. Unfortunately, a significant drop in performance was noticed for the SAZn@BC air-dried after reaction with TMP, FIG. 14A. The change of the catalyst surface chemical structure could be one of the reasons for the performance decline. A comparison of the O 1s spectrum of XPS showed a substantial decrease of the C—O bond at 533.30 eV and an increase of C═O at 531.18 eV after the reaction (FIGS. 15A and 15B). This change was also supported by the C 1s spectrum, likely from the consumption of phenolic groups and transformation of hydroquinone to quinone moieties. The blockage of micropores and active sites by undegraded TMP could be another reason for the reduced performance of SAZn@BC. Interestingly, simple heating at 100° C. and 250° C. significantly improved the catalytic performance of SAZn@BC to a level comparable to the original catalyst. Unfortunately, after one cycle of heating, SAZn@BC regenerated at 100° C. showed poor performance even after heating at the same temperature again, FIG. 14B. This may be due to the carbonization of TMP on the surface. However, SAZn@BC regenerated at 250° C. roughly maintained its efficacy for TMP removal after second heating, suggesting that high temperature heating might be a simple but effective approach to regenerate the catalyst. This is attributed to the fact that the higher temperature favors the formation of redox active phenolic and hydroquinone moieties on biochar, a critical factor in the catalytic function of SAZn@BC as discussed above.

### Example 1H

### Removal Efficiency for Trimethoprim (TMP)

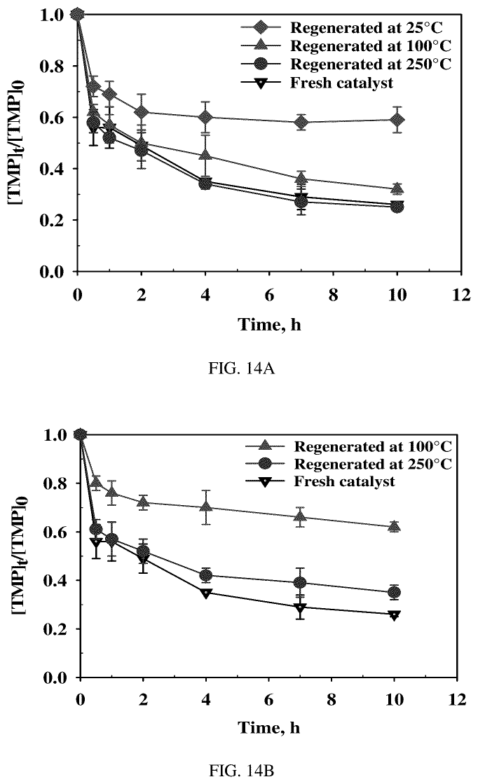

To further evaluate the efficacy of the synthesized Zn single atom biochar, the removal efficiency for trimethoprim (TMP) was evaluated with 0.10 g/L and 0.25 g/L of SAZn@BC (also written as Zn SACs) containing 1 wt % of Zn as metal active sites for 4 hours. 0.25 g/L of SAZn@BC eliminated 77.2% of 10 μM TMP, and 0.10 g/L of Zn SAC removed 48.3% of 10 μM TMP in 4 hours (FIG. 16). As indicated in FIG. 16, during the initial 30 min, the concentration of TMP sharply decreased for both 0.25 g/L and 0.10 g/L of SAZn@BC, and the changes in the concentration of TMP after 30 min were negligible for both concentrations of Zn SACs. From a former experiment, 0.40 g/L of SAZn@BC showed 98% removal efficiency for the identical concentration of TMP under the same conditions. Those results demonstrated that the increase in the amount of catalyst with the same concentration (1 wt %) resulted in higher removal efficiencies. Herein, to investigate the TMP degradation mechanisms during the initial 30 min with SAZn@BCs, 0.25 g/L of the catalyst was selected as an optimal dosage for 10.0 μM TMP. These results confirmed that the Zn SACs alone can remove environmental contaminants.

### Example 1I

### Effects of Environmental Factors

Unlike the controlled conditions in laboratory investigations, where parameters can be meticulously regulated, the real environment presents a diverse array of factors that affect the contaminant degradation process. Variations in pH can profoundly impact the surface charge and chemical reactivity of single-atom catalysts, thereby affecting their efficacy in removing contaminants. Moreover, the presence of anions that are ubiquitous constituents of natural environments introduces complexity with interactions ranging from surface adsorption behavior to competitive inhibition of catalytic sites, ultimately shaping the fate of contaminants under diverse environmental conditions.

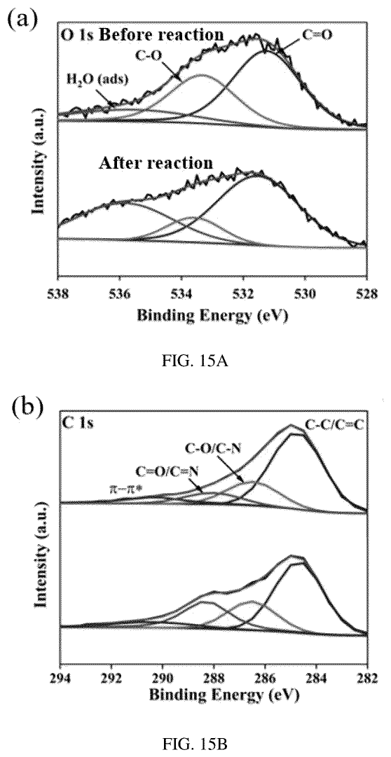

Before evaluating the effects of pH on the catalytic performance of Zn SACs, the pH of zero point of charge (pH_{zpc}) of Zn SAC anchored on biochar support was measured to provide an understanding of the surface characteristics of SAZn@BC. The pH_{zpc} represents the pH at which the surface charge of the SAC becomes zero, signifying the equilibrium between protonation and deprotonation reactions on the catalyst surface. At pH<pH_{zpc}, the surface of SACs has a net positive charge, while the surface charge of SACs has a net negative charge at pH>pH_{zpc}. The pH_{zpc} of Zn SAC was 4.8, determined by the acid-base titration method with 0.1 M of HCl and 0.1 M of NaOH (FIG. 17). As shown in FIG. 17, the value of pH_{zpc} of Zn SAC indicated that it was positively charged at a lower pH than 4.8, and negatively charged at a higher pH than 4.8.

The impacts of pH on trimethoprim (TMP) degradation by Zn SACs were studied at a wide range of pH conditions, specifically pH 4.0, 6.0, and 8.0, which represents most common range of pH in natural water. The TMP removal efficiencies by Zn SAC at pH 4.0, 6.0, and 8.0 are depicted in FIG. 17. The experimental data revealed a distinct trend in TMP removal efficiency, depending on pH. The TMP removal efficiencies by Zn SACs at pH 4.0, 6.0, and 8.0 were 52%, 77%, and 81% within 30 min, respectively. Notably, Zn SACs exhibited the lowest TMP removal efficiency at pH 4.0, indicating that the performance of Zn SACs decreased at pH 4.0. This observation aligns with the surface charge characteristics elucidated by the pH_{zpc} value, indicating that Zn SACs possess a positively charged surface at pH 4.0 (pH_{zpc} of Zn SACs=4.8). Trimethoprim also carries a positively charged surface at pH 4.0 (pKa of TMP=7.12), leading to a reduction in the adsorption capacity on the surface of Zn SAC by generating the electrostatic repulsion between Zn SAC and TMP. Conversely, at pH 6.0 and 8.0, the removal efficiencies of TMP by Zn SAC were comparable, suggesting a relatively stable catalytic performance at pH 6.0 and 8.0. Based on theoretical predictions derived from the pH_{zpc} of Zn SAC and pKa of TMP, it was anticipated that the negatively charged Zn SAC at pH 6.0 and 8.0 would exhibit a higher removal efficiency at pH 6.0, where 90% of TMP remain positively charged, than at pH 8.0 where most of TMP are negatively charged. Contrary to expectation, the experimental data showed a slightly better removal efficiency of TMP at pH 8.0 compared to pH 6.0. This unexpected outcome propounded a question regarding the underlying mechanisms governing TMP removal at pH 8.0. These results underscore the intricate relationship between the surface properties of single-atom catalysts (SACs) and the pH, highlighting the importance of pH optimization to enhance the efficacy of SACs-based water treatment strategies.

### Example 1J

Adsorption Vs. Degradation

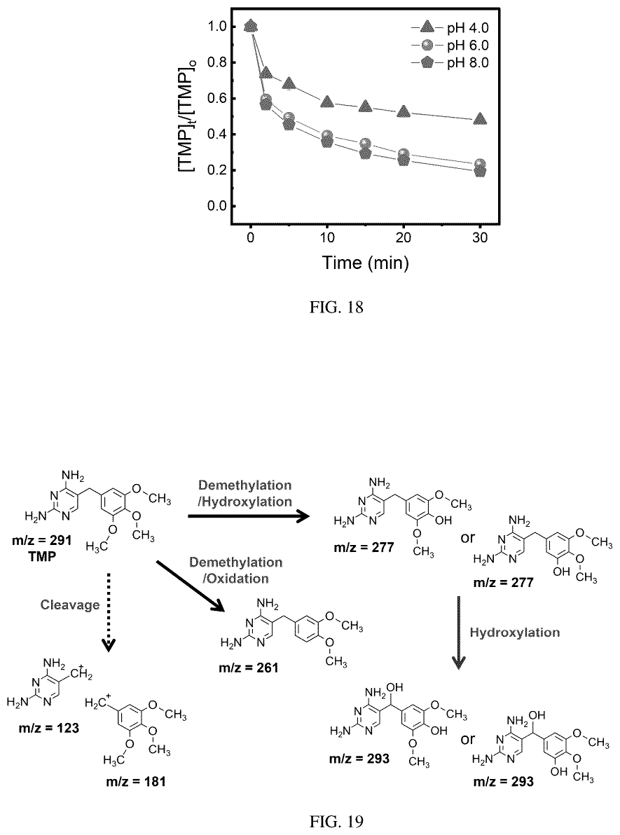

To identify metabolites and understand the removal mechanisms of TMP by Zn SACs during the initial 30 min, the samples were collected at different retention times (0, 5, 15, and 30 min), and untargeted analysis was conducted by the liquid chromatography high-resolution accurate mass spectrometry (LC/MS). Other studies have shown that TMP commonly undergoes hydroxylation, oxidation, and methylation as the initial stage of degradation, and the common degradation products are summarized in FIG. 5. In this investigation, some of the degradation products were detected, and the plausible degradation pathways are proposed in FIG. 19. Metabolites, resulting from demethylation/hydroxylation, demethylation/oxidation, and cleavage of TMP were observed. As can be seen in FIG. 19, the degradation products by the demethylation reaction, such as 5-[(2,4-diamino-5-pyrimidinyl)methyl]-2,6-dimethoxy-phenol or 5-[(2,4-diamino-5-pyrimidinyl)methyl]-2,3-dimethoxy-phenol (m/z=277, C₁₃H₁₆O₃N₄), were detected at all pH range. The results of demethylation and oxidation reactions of TMP, such as 5-[(2,4-diamino-5-pyrimidinyl)methyl]-3,4-dimethoxy-benzyl (m/z=261, C₁₃H₁₆O₂N₄), were identified for all pH range. The products by the cleavage of TMP were also observed, showing 2, 4-diamino-5-methyl pyrimidine (m/z=123, C₅H₇N₄) and 1,2,3-trimethoxy-5-methyl-benzene species (m/z=181, C₁₀H₁₃O₃).

TABLE 5
Possible degradation pathways and reaction products of TMP

| Pathway | Structure | Formula | MW | m/z |
|---|---|---|---|---|
| — | 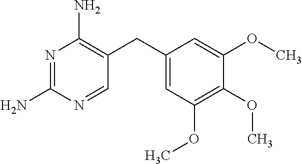 [SMILES: COc1cc(Cc2cnc(N)nc2N)cc(OC)c1OC] | C₁₄H₁₈N₄O₃ | 290 | 291 |
| Hydroxylation | 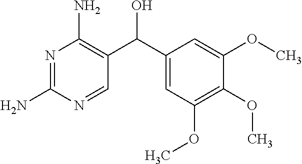 [SMILES: COc1cc(C(O)c2cnc(N)nc2N)cc(OC)c1OC] | C₁₄H₁₈N₄O₄ | 306 | 307 |
| Hydroxylation | 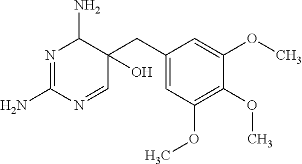 [SMILES: COc1cc(CC2(O)C=NC(N)=NC2N)cc(OC)c1OC] | C₁₄H₂₀N₄O₄ | 308 | 309 |
| Hydroxylation | 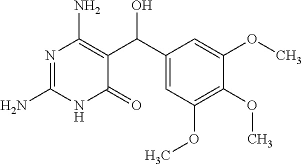 [SMILES: COc1cc(C(O)c2c(N)nc(N)[nH]c2=O)cc(OC)c1OC] | C₁₄H₁₈N₄O₅ | 322 | 323 |
| Oxidation | 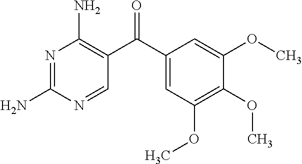 [SMILES: COc1cc(C(=O)c2cnc(N)nc2N)cc(OC)c1OC] | C₁₄H₁₆N₄O₄ | 304 | 305 |
| Demethylation | 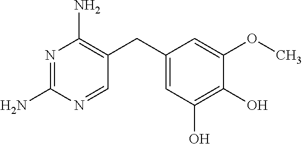 [SMILES: COc1cc(Cc2cnc(N)nc2N)cc(O)c1O] | C₁₂H₁₄N₄O₃ | 262 | 263 |
| Demethylation | 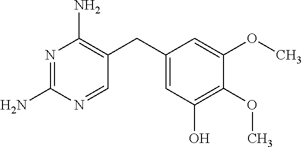 [SMILES: COc1cc(Cc2cnc(N)nc2N)cc(O)c1OC] | C₁₃H₁₆N₄O₃ | 276 | 277 |

All metabolites were identified at pH 4.0, 6.0, and 8.0. The untargeted analysis of LC/MS data highlighted that Zn SACs exhibited the potential to concurrently facilitate the degradation and adsorption of TMP within a relatively short retention time of only 30 min. These results also supported the versatility and efficiency of Zn SACs in addressing organic contaminant treatment challenges.

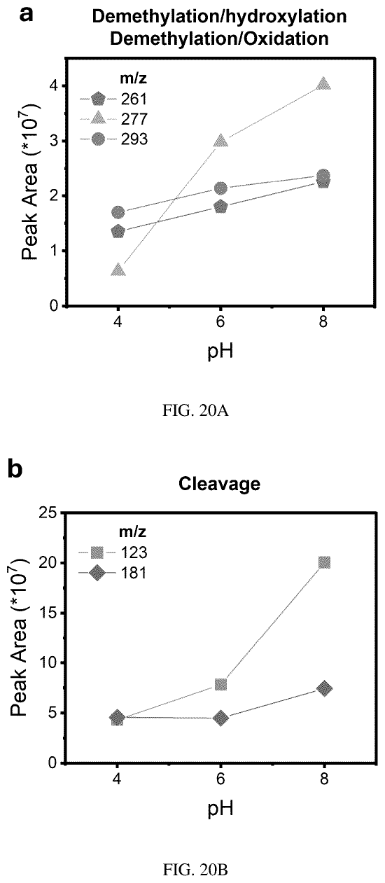

The peak areas or abundances of each metabolite at three pH conditions (pH 4.0, 6.0, and 8.0) are presented in FIGS. 20A and 20B. The abundances of all metabolites were dependent on pH, and interestingly, all identified metabolites displayed a pronounced increase in peak area with an increase in pH. As illustrated in FIG. 20A, the degradation products by demethylation/hydroxylation or demethylation/oxidation reactions showed the highest peak area at pH 8.0, and this trend was consistent with the degradation products by cleavage reactions (FIG. 20B). This result indicated that TMP was much more actively degraded by Zn SACs at pH 8.0 compared to pH 4.0 and pH 6.0. These results substantiated a previous finding that Zn SACs showed a higher removal efficiency for TMP at pH 8.0 (81%) than at pH 6.0 (77%) and pH 4.0 (52%).

However, the removal efficiency of TMP by Zn SACs was similar at pH 6.0 and pH 8.0 while the degradation products were much more abundant at pH 8.0 compared to pH 6.0. Without being bound by any theory, the findings indicate that adsorption was a more dominant process than degradation for the removal of TMP at pH 6.0. It was also supported by the investigation of pH_{zpc} of Zn SACs and the pKa value of TMP. Zn SACs had a negatively charged surface at pH 6.0 (pH_{zpc}=4.8) while TMP had a positively charged surface at pH 6.0 (pKa=7.12), resulting in the electrostatic attraction of each other. In contrast, at pH 8.0, both Zn SACs and TMP were negatively charged, meaning that adsorption could not be the dominant behavior for TMP removal at pH 8.0. As shown in the metabolite studies, however, the highest concentration of degradation products of TMP was observed at pH 8.0 in comparison with pH 4.0 and pH 6.0 (FIGS. 20A and 20B). Therefore, the highest removal efficiency of TMP by Zn SACs at pH 8.0 may be ascribed to the active degradation rather than the adsorption on the surface of Zn SACs. This study clarified the role of adsorption and degradation in TMP degradation by Zn SACs.

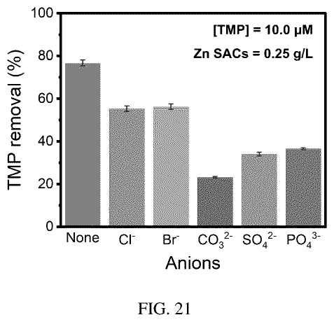

In actual wastewater and natural waterbodies, there exists a variety of anionic species derived from natural sources, anthropogenic activities, and industrial processes. Common anions encountered in waterbodies include chloride ion (Cl⁻), bromide ion (Br⁻), carbonate ion (CO₃²⁻), sulfate ion (SO₄²⁻), and phosphate ion (PO₄³⁻). The experimental results, illustrated in FIG. 21, implied that the existence of anions had negative effects on the removal efficiency of TMP by Zn SAC. Specifically, Zn SAC removed 77% TMP without any anions within 30 min, while the removal efficiency of TMP by Zn SACs synthesized under the same conditions decreased from 77% to 23% with the presence of 50 mM CO₃²⁻. The extent of the decrease in the removal efficiency of TMP by Zn SAC was dependent on the species of anions. The monovalent anions such as Cl— and Br— had a lower impact on the removal of TMP by Zn SAC compared to divalent anions (CO₃²⁻ and SO₄²⁻) and trivalent anions (PO₄³⁻).

### Example 2A

### PFAS Adsorption on Carbon-Based Adsorbents

Adsorption as a standalone technology for PFAS removal has been widely explored. Previous efforts in adsorption generally proceed along two research lines: probing the molecular mechanisms of PFAS adsorption and developing high-capacity and selective adsorbents. Hydrophobic and electrostatic interactions are usually considered the two most dominant forces governing PFAS adsorption on carbonaceous adsorbents. However, the poor correlation between conventional indicators of an adsorbent's capacity (e.g., pore size distribution and specific surface area) and their PFAS adsorption performance suggests the presence of other significant factors affecting PFAS adsorption.

Over the years, the scientific community has strived to establish correlations between PFAS adsorption on different environmental surfaces and their molecular properties, such as the head functional groups and carbon chain length. Several consistent trends have been reported. For example, more hydrophobic, long-chain PFAS tend to exhibit greater adsorption capacity than their more hydrophilic, short-chain counterparts. Additionally, PFAS with sulfonic acid functional groups adsorb more effectively than those with carboxylic acid functional groups.

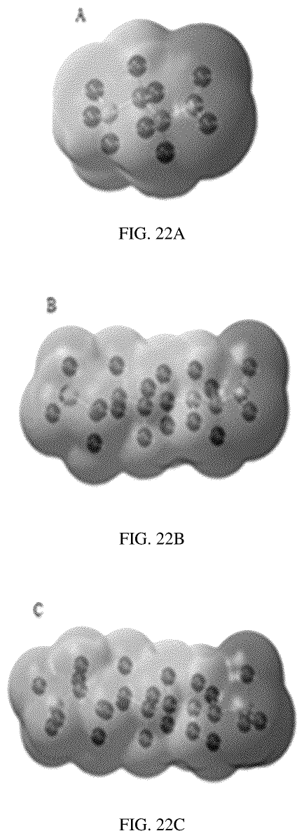

The adsorption of three PFAS with different properties (PFOA, PFOS, and perfluorobutanoic acid (PFBA)) on pristine biochar have been measured. To gain further mechanistic insight, Density Functional Theory (DFT) calculations were performed to analyze the electrostatic potential surfaces (EPS) of different PFAS anions, as shown in FIGS. 22A-22C. The results indicate that the negative charge resulting from the deprotonation of the head functional groups is concentrated primarily on the carbon atoms near these functional groups. This suggests that while hydrophobic interactions play a significant role in the adsorption of long-chain PFAS anions, electrostatic interactions are likely more dominant in the adsorption of short-chain PFAS. These findings may also explain the unique phenomenon where long-chain PFAS form large aggregated clusters on the hydroxyl surface of kaolinite at high concentrations-a behavior not observed for short-chain PFAS.

In addition to the properties of PFAS molecules, the characteristics of the adsorbent play a crucial role in the overall adsorption process. Biochar exhibits relatively lower adsorption capacity for PFAS than other carbonaceous adsorbents, but its adsorption can be improved through various surface modification strategies, such as the incorporation of oxygen- or nitrogen-containing functional groups (e.g., NH₂). Oxygen-containing groups can enhance hydrogen bonding, while amine-containing functional groups may strengthen electrostatic interactions. Specifically, the carbon-oxygen double bond (C═O) can create high-energy adsorption sites for anionic PFAS. However, density functional theory (DFT) calculations indicate that oxygen-containing functional groups tend to lower the adsorption of PFAS on the surrounding carbon due to increased negative charge. Interestingly, metal or metal oxide nanoparticles are often used to enhance the adsorption of biochar for different environmental pollutants. This prompted the investigation of how the metal atoms in SAMCs could affect PFAS adsorption and, ultimately, their removal in the catalytic system.

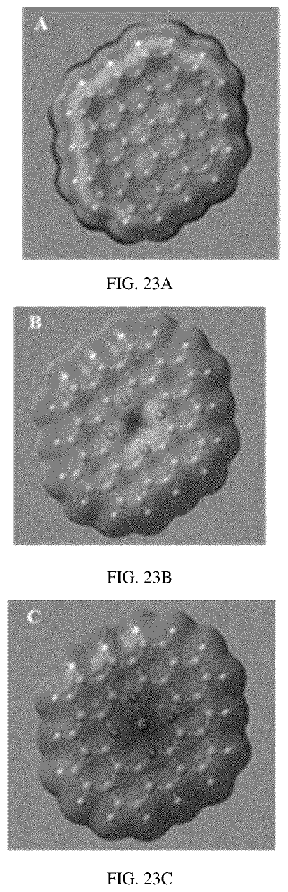

Preliminary studies indicate that the electron distribution of the biochar supporting material, which is typically negatively charged, can be altered by incorporating metal atoms in its matrix, as shown in FIGS. 23A-23C. This modification suggests a potential improvement in PFAS and PMS/PDS adsorption. The charge state of Zn (+2) was confirmed in the preliminary study with X-ray photoelectron spectroscopy (XPS), corroborating the slightly higher adsorption of several PFAS compounds on SAZn@BC. This modified ESP may also explain the significantly higher adsorption of PFAS on SAFe@BC, as the experimental results revealed that Fe atoms in the biochar support exhibit mixed +2 and +3 oxidation states, which likely enhance the electrostatic interactions between the SAFe@BC and anionic PFAS. In the field of SAMC, an emerging trend involves the synthesis of dual-metal single-atom catalysts or catalysts that incorporate both single metal atoms and their small clusters. These modified SAMCs have demonstrated greater catalytic activity, yet how the adsorption of contaminants such as PFAS and PMS/PDS is affected by the modified metal atom states has not been explored (FIG. 24). Understanding this is crucial for further improving the effectiveness of SAMCs for PFAS removal.

### Example 2B

### Removal of PFAS by Atomically Dispersed Metal Catalysts on Biochar

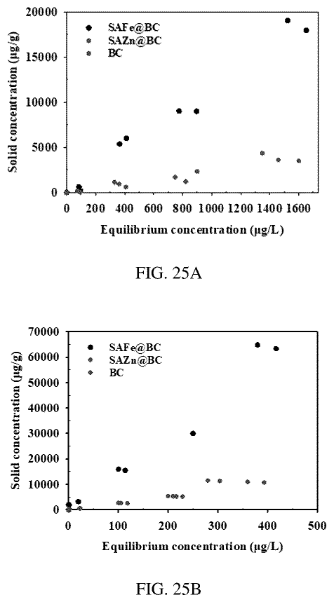

The removal of three PFAS compounds by atomically dispersed iron catalyst on biochar (BC-Fe) and atomically dispersed zinc catalyst on biochar (BC-Zn) was investigated. While the PFAS removal by the zinc biochar catalyst was comparable with the control biochar without any metal atoms, the iron biochar has significantly increased the removal of three PFAS: perfluorooctanoic carboxylic acid (PFOA), perfluorooctanoic sulfonic acid (PFOS) and perfluorobutanoic carboxylic acid (PFBA). This is likely due to the markedly enhanced adsorption of PFAS by BC-Fe. The adsorption isotherms of the three PFAS on different BC were measured, FIGS. 25A-25C, and the adsorption capacity of BC-Fe was substantially higher than other two products. The specific surface area of these three products was also measured, Table 6, which showed that the elevated adsorption was not due to the enlarged specific surface area.

TABLE 6
Specific surface area of three different biochar products

| | BET Surface Area | Langmuir Surface |
|---|---|---|
| | (m²/g) | Area (m²/g) |
| BC-Zn | 33.1076 | 312.0826 |
| BC-Fe | 111.0182 | 682.4846 |
| Biochar (BC) | 313.1946 | 491.739 |

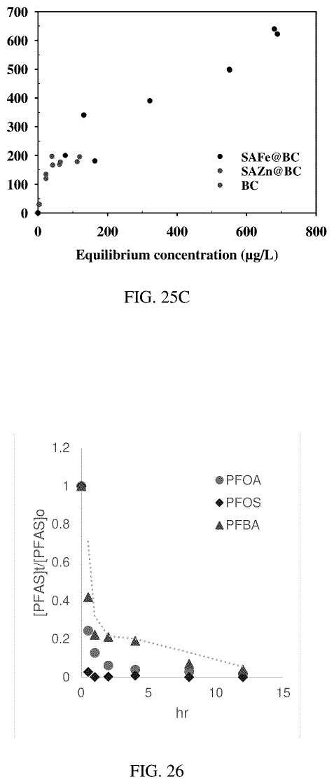

In fact, the BET surface area of both metal catalyst biochar was smaller than the control biochar, yet displaying either much greater or similar adsorption capacity, suggesting that the metal atoms in biochar matrix created favorable environmental for these three anionic PFAS. It was also found that the adsorption is fast, and it often experiences a rapid PFAS removal process in the first 30 minutes and then slowly decrease afterwards. The adsorption kinetics of three PFAS compounds on BC-Fe is shown in FIG. 26. The kinetics is especially fast for long chain PFAS. Within the time frame of the study, PFAS metabolites were not detected, suggesting that in the initial stage, rapid adsorption is the main mechanism for PFAS removal by biochar with atomically dispersed metals. However, the electrocatalytic property of the atomically dispersed metal biochar can potentially lead to PFAS degradation over longer time or in the presence of an external oxidant.

### Example 2C

### PFAS Degradation by Iron/Zinc Dual-Metal Single-Atom Catalysts (Fe/Zn DACs)

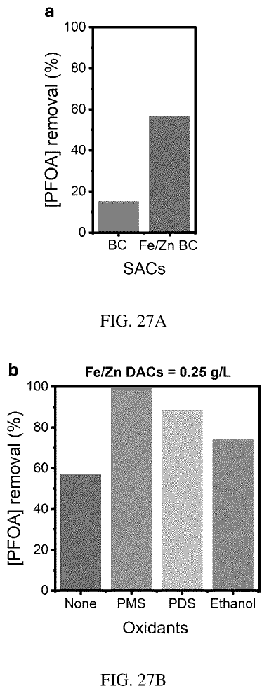

Dual-metal single-atom catalysts (DACs) were synthesized comprising iron (Fe) and Zinc (Zn) single atoms as dual active sites and assessed its efficacy for PFAS degradation, FIG. 27A. It was demonstrated that Fe/Zn DACs displayed a much higher performance for PFOA degradation compared to biochar without metal species. At the same conditions, Fe/Zn DACs eliminated 57% of PFOA while biochar without metal species removed only 15% of PFOA in 30 min. With a combination of oxidants, the catalytic performance of Fe/Zn DACs markedly increased. Fe/Zn DACs removed 74%, 89%, and 99% of PFOA with ethanol, PDS, and PMS, respectively (FIG. 27B). The findings indicated that the corporation of Fe/Zn DACs and oxidants showed superior characteristics for PFOA elimination in water.

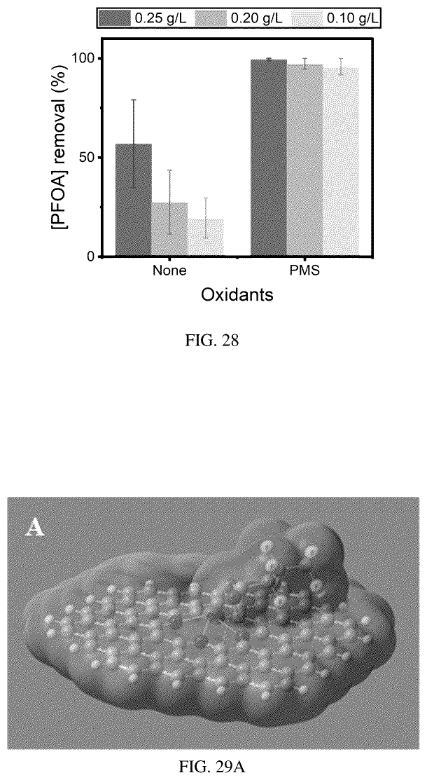

To further understand the mechanisms underlying PFOA degradation by Fe/Zn DACs, experiments were undertaken with varying concentrations of Fe/Zn DACs (0.25 g/L, 0.20 g/L, and 0.10 g/L) in conjunction with the addition of 0.5 mM of PMS as an oxidant. Interestingly, the experimental data consistently demonstrated high removal efficiencies of PFOA when Fe/Zn DACs were combined with PMS (FIG. 28). As detailed, the system combined with PMS always exhibited almost 100% removal efficiencies for PFOA regardless of the concentration of Fe/Zn DACs while the removal efficiencies of PFOA by Fe/Zn DACs alone in the system proportionally decreased with a decrease in the amount of Fe/Zn DACs. In other words, the enhanced PFOA degradation was observed in the presence of PMS, resulting from the synergistic effect between Fe/Zn DACs and PMS. It is important to note that these results were obtained at ambient temperature and pH conditions, showing the promising use of SACs in water treatment.

### Example 3A

### Determination of Adsorption Kinetics and Capacity of PFAS Compounds on Different Single Atom Metal Catalysts on Biochar Support

In the instant prophetic example, six regulated PFAS compounds by USEPA are selected (Table 7). These compounds are not only relevant to public health but also possess diverse molecular structures and functional groups that can shed significant mechanistic insight into their adsorption to SAMCs.

TABLE 7
Molecular structure and properties of six selected PFAS compounds

| | | C-F | Chain | | |
|---|---|---|---|---|---|
| PFAS | Molecular structure | number* | length | LogK_{ow} | pKa |
| PFNA | 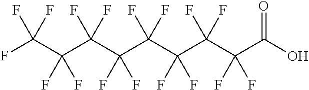 [SMILES: O=C(O)C(F)(F)C(F)(F)C(F)(F)C(F)(F)C(F)(F)C(F)(F)C(F)(F)C(F)(F)F] | 8 | 9 | — | −0.21 |
| PFOA | 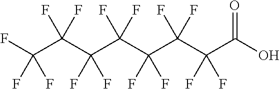 [SMILES: O=C(O)C(F)(F)C(F)(F)C(F)(F)C(F)(F)C(F)(F)C(F)(F)C(F)(F)F] | 7 | 8 | 6.3 | 1.30 |
| PFOS | 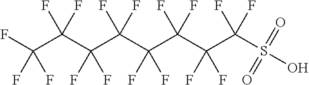 [SMILES: O=S(=O)(O)C(F)(F)C(F)(F)C(F)(F)C(F)(F)C(F)(F)C(F)(F)C(F)(F)C(F)(F)F] | 8 | 8 | — | =<1.0 |
| PFHxS | 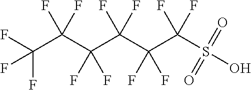 [SMILES: O=S(=O)(O)C(F)(F)C(F)(F)C(F)(F)C(F)(F)C(F)(F)C(F)(F)F] | 6 | 6 | 4.03 | −3.32 |
| PFBS | 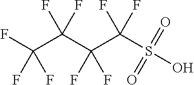 [SMILES: O=S(=O)(O)C(F)(F)C(F)(F)C(F)(F)C(F)(F)F] | 4 | 4 | 2.63 | −3.31 |
| HFPO-DA | 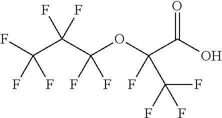 [SMILES: O=C(O)C(F)(OC(F)(F)C(F)(F)C(F)(F)F)C(F)(F)F] | 5 | 5 | — | 2.84 |

*the number of fluorinated carbons.

### Synthesis and Characterization of Single-Atom Metal Catalysts on Biochar Support

To evaluate the role of metal single atoms in the adsorption of PFAS and PMS/PDS, a range of SAMC on biochar support will be synthesized. Specifically, SAMCs of zinc (Zn), copper (Cu), iron (Fe), cobalt (Co), nickel (Ni), palladium (Pd), and aluminum (Al) on biochar support will be synthesized. These metals have different radial sizes and valence states and are abundant in the environment. Several of them, such as Co and Pd, are common elements for SAMCs.

Briefly, oak wood powders with negligible background metal content will be used as the biochar feedstock. For synthesizing the SAMC on biochar, 10.0 g of wood powder, 5.0 g of dicyandiamide, and different amounts of metal salts (e.g., zinc nitrate) will be mixed with 150 mL of ultrapure water at 500 rpm and 90° C. for one hour. The mixture will then be dried in an oven at 85° C. for 20 hours before pyrolysis, which will be carried out in a box furnace (Fisher Scientific, USA) for three hours with a continuous flow of nitrogen gas. The peak temperature will be set at 400-1000° C. to produce products containing different amounts of oxygen functional groups and M (metal)-Nₓ—C coordination structures. Previous studies have shown that even though M-N₄ is the most common and stable structure, modification of pyrolysis conditions will generate undersaturated (e.g., M-N₃—C) or oversaturated (e.g., M-N₅—C) coordination structure, which often demonstrates greater catalytic activity. Thus, in addition to delineating the role of different metal atoms, how the local coordination structure affects the adsorption of PFAS on these catalysts will be evaluated. These studies will reveal whether improved adsorption may partially account for the overall enhanced catalytic activities of SAMCs with undersaturated or oversaturated coordination structures.

Following studies on single metals, SAMCs with dual metal single atoms (e.g., Fe and Co in different ratios) and or single metal but containing both single atoms and atomic clusters will be synthesized. The latter can usually be achieved by adjusting the concentration of metal salts in the synthesis process. The pristine product will be acid-washed and then collected by vacuum filtration through a 0.45 μm membrane and washed with 2.0 L ultrapure water. The single atom state of metals will be confirmed with different characterization techniques as described below. As a control, biochar with 0 wt % metal loading will be synthesized at the same pyrolysis conditions.

Characterization: The morphology of the catalyst will be determined by transmission electron microscopy (TEM). A high-angle annular dark field (HAADF) detector will be utilized to identify single metal atoms and atom clusters, and a Super-X EDS detector will be used to map the distribution of C, N, O, and metal elements on biochar, as shown in FIGS. 3A-3I. X-ray absorption spectroscopy (XAS) will be used to confirm the single-atom state of metal and the local coordination structure. The data will be processed and fitted using the IFEFFIT-based Athena and Artemis software packages. Due to the importance of metal atom oxidation states in regulating the local electronic states, X-ray photoelectron spectroscopy (XPS) analysis will be conducted to determine the valence state of metal atoms or clusters in SAMCs. The precise abundance of metal atoms will be confirmed with inductively coupled plasma mass spectrometry (ICP-MS). Due to the potential contribution of the biochar support to PFAS and PMS/PDS adsorption, the specific surface and pore size distribution of the biochar support will be determined using BET (Brunnauer, Emmett, and Teller) method. The crystal structure of the biochar, which can affect the adsorption of PFAS, may vary with the pyrolysis condition and thus will be determined using X-ray diffraction (XRD). The possible O and N containing functional groups on biochar contained in the original feedstock materials will be determined using XPS.

### Example 3B

### Measurement of Adsorption Kinetics and Isotherms in Deionized Water

Batch reactors will be used to determine the adsorption kinetics and isotherms of different PFAS molecules and PMS/PDS on well-characterized SAMCs. For the kinetics measurements, the initial concentration of PFAS will be fixed at 100 ppb, and the duration will be approximately 12 hours. These parameters will be chosen based on preliminary results with the adsorption of three PFAS on biochar containing iron single atoms showing that the adsorption reached apparent equilibrium within 8 to 10 hours, FIG. 26. The adsorption of long-chain PFAS generally showed faster adsorption kinetics. Regardless of the carbon chain length, all PFAS seemed to experience a two-stage adsorption process, with a rapid adsorption stage within 30 minutes, followed by a slower adsorption stage, suggesting that the SAMCs on biochar contain heterogeneous adsorption sites. It is speculated that the high-energy adsorption site for PFAS is generated by the metal single atom sites, and the low-energy adsorption site is provided by the biochar support. To capture the kinetics in both stages, samples will be taken at 5 min, 15 min, 30 min, 1 hour, 3 hours, 6 hours, and 12 hours. The collected samples will be purified through solid phase extraction and analyzed with a high-resolution liquid chromatography tandem mass spectrometry (LC/MS/MS).

To measure adsorption isotherms, the concentration of SAMCs will be fixed at 0.2 g/L, while PFAS concentrations will vary from 1 μg/L to 10 mg/L, spanning four orders of magnitude. The lower concentration is near the detection limit of LC/MS/MS (around 0.25 ng/ml), while the higher concentration is selected to potentially induce adsorbate-adsorbate interactions, such as PFAS aggregation or micelle formation, especially for long-chain PFAS. This may significantly impact the adsorption capacity of PFAS and allow the identification points of drastic changes in isotherms, possibly due to micelle formation in the liquid phase or cluster formation on the solid surface, or both. Detailed insights will be obtained from parallel molecular simulation as detailed below. For both kinetics and isotherm measurements, biochar containing 1-2% metal single atoms will be used, with models applied to further understand adsorption mechanisms. Specifically, the adsorption kinetics of PFAS will be modeled with Richie's equation, which has the general form of:

$$\frac{d θ}{d t} = {α ( 1 - θ )}^{n}$$

Where 0 is defined as the ratio of qₜ (solid concentration of PFAS on single-atom metal catalyst on biochar) over q_{∞} (the adsorption capacity of PFAS on the same adsorbent, which can be estimated from the adsorption isotherm), n is the pseudo-nth-order of adsorption and a is a fitting parameter. Richie's equation is selected as the primary kinetic model because it assumes that the adsorption primarily occurs on active sites of a heterogenous surface, and it has been successfully used to model the adsorption of ions on biochar. If this kinetic modeling does not fit the whole kinetics data well, a two-stage approach will be explored by modeling the first stage of adsorption with Richie's model and the second stage of adsorption kinetics with pseudo-first-order or pseudo-second-order models, commonly used to model kinetics of environmental pollutants on carbonaceous adsorbents.

Mathematical fitting of adsorption isotherms will be performed to gain insights into the adsorption affinity and capacity of PFAS on the biochar. Many empirical and theoretical models have been developed to fit adsorption isotherms, with some assuming one-layer adsorption or homogenous systems. These assumptions deviate from the nature of PFAS adsorption (e.g., the capability of long-chain PFAS to form clusters on the surface of adsorbents) and the single atom metal catalyst on biochar, which is heterogenous. Therefore, Tóth isotherm model, which assumes a heterogenous adsorbent with the energy of most adsorption sites smaller than the mean energy, will be applied first to evaluate its feasibility for PFAS isotherm fitting. If the model does not fit the data well, the two-step adsorption model will be applied. The two-step model has three parameters and is more complicated than other commonly applied models, but it has been successfully used to fit the adsorption of some surfactants on environmental surfaces. The two-step model has the general form of:

$${q}_{t} = \frac{{Qk}_{1} C ( \frac{1}{n} + {k}_{2} {C}^{n - 1} )}{1 + {k}_{1} C ( 1 + {k}_{2} {C}^{n - 1} )}$$

In which qₜ, Q, and C represent the solid concentration, the maximum adsorption, and the liquid concentration of PFAS, respectively. k₁, k₂, and n are fitting parameters.

For the PMS and PDS adsorption, the primary goal will be focused on measuring the adsorption capacity and calculating the bonding energy of their adsorption to SAMCs. Their concentration will be fixed at 500 μM and 5 mM, the typical concentration of PMS/PDS used in sulfate radical-based systems. Due to the likely activation of adsorbed PMS/PDS, sulfite or nitrite will be added to the solution to poison the active sites to gain information on the adsorption of PMS/PDS. This study will be closely coordinated with the simulation efforts. Their concentrations in the solution will be quantified with a high-performance liquid chromatography (HPLC).

### Example 3C

### Determination of the Impact of pH on the Adsorption of PFAS and PMS/PDS

pH plays a crucial role in the speciation of PFAS and the functional groups on biochar and is expected to substantially affect the adsorption of PFAS and PMS/PDS. In this study, pH values will be adjusted from 4.0 to 10.0 before adsorption to determine its effect on the adsorption capacity of PFAS and PMS/PDS. The study will be performed with the SAMC on biochar displaying the highest adsorption capacity for the tested PFAS. Parallel experiments will also be conducted with biochar without metal single-atom for comparison.

TABLE 8
Highest concentrations of inorganic ions to be investigated.

| | Concentration |
|---|---|
| Ions | (mmol/L) |
| Na⁺ | 85 |
| Ca²⁺ | 3.0 |
| Mg²⁺ | 1.5 |
| Fe³⁺ | 0.2 |
| Mn²⁺ | 0.03 |
| Cl⁻ | 85 |
| SO₄²⁻ | 10 |

### Example 3D

### Determination of the Impact of Common Water Cations and Anions on the Adsorption of PFAS and PMS/PDS

Ions present in natural water may have an appreciable impact on PFAS adsorption via charge bridging, competitive adsorption, and or other mechanisms. In this study, the impact of predominant multi-valent cations and anions will be investigated on the adsorption of PFAS and PMS/PDS, excluding Na⁺ and Cl⁻. The ions and their highest concentrations, based on the upper limits found in typical natural water, are summarized in Table 8 and will be used in the initial investigations. If an ion exhibits a notable effect on PFAS adsorption at the concentration listed, additional experiments will be conducted to explore its impact at lower concentrations.

### Example 3E

### Elucidation of the Impact of Dissolved Organic Matter (Fulvic Acid, Humic Acid, and Natural Organic Matter) on PFAS and PMS/PDS Adsorption

Dissolved organic matter (DOM) is ubiquitous in natural water bodies and is known to affect adsorption. Although DOM is generally viewed as inhibitive to adsorption, the degree of inhibition reported in various studies ranges from slight to substantial, suggesting that the specific properties of DOM and PFAS play a critical role in their interactions. In this study, three well-characterized DOM products from the International Humic Substances Society (IHSS), including Suwannee River fulvic acid (SRFA), humic acid (SRHA), and natural organic matter (SRNOM), will be tested. Two DOM concentrations, ranging from 1-15 mg/L (the typical range in natural waters), will be assessed for their impact on PFAS and PMS/PDS adsorption. If DOM exhibits property-dependent effects on PFAS adsorption, the DOM properties will be characterized, aiming to establish correlations between DOM properties and their impact on PFAS adsorption to SAMCs.

### Example 3F

### Assessment of Surface Functionalization on the Adsorption of PFAS and PMS/PDS

Surface functionalization with oxygen-containing functional groups has been demonstrated to significantly affect the adsorption properties of carbonaceous adsorbents. Pyrolysis temperature has a marked effect on the types of oxygen-containing functional groups on biochar surface, leading to different electron donating and accepting capacities of the biochar surface. For example, at the pyrolysis of <400° C., most functional groups in the feedstock will be retained, which is represented by the phenolic moieties (C—O); however, at moderate temperatures (e.g., 400-550° C.), quinone (C═O) becomes the dominant oxygen functional groups. At higher pyrolysis temperatures (>800° C.), most oxygen functional groups are thermally degraded, resulting in a graphitized carbon sheet with minimal oxygen functional groups. Given the importance of electrostatic interactions in PFAS adsorption, the presence and nature of surface oxygen functional groups on the biochar supporting material may affect PFAS interaction with the metal active sites on SAMCs and consequently affect PFAS adsorption and degradation. Under this study, the properties of oxygen functional groups will be determined by XPS before the adsorption study. It is noteworthy that the impact of surface functional groups on biochar support cannot be fully separated from the interactions of PFAS with the metal active sites experimentally; integrated experimental and simulation studies will be adopted for this task.

### Example 3G

### Density Functional Theory (DFT) Calculations and Molecular Dynamics Simulations

All prophetic studies will be systematically supported by multiscale modeling and simulations. While few computational studies have focused on the adsorption of PFAS on SAMCs, existing research on other adsorbents such as clay, metal oxides, and anionic resins highlights the value of computational methods in understanding adsorption mechanisms. In this study, first-principle DFT calculations and all-atom Molecular Dynamics (AA-MD) simulations will be employed to investigate the molecular-level behavior of PFAS adsorption on SAMC supported by biochar, both in the presence and absence of PMS/PDS at ideal (deionized water) and more realistic conditions. These computational approaches will help elucidate how structural factors (e.g., single metal atoms) and environmental factors influence PFAS removal by SAMCs, providing key insights into the underlying mechanisms.

### DFT Calculations

A systematic series of DFT calculations will be performed to gain molecular-level insights into the adsorption of various PFAS on SAMCs with different metal atoms or atom clusters. These calculations will elucidate how different metal types, coordination environments, and structural factors affect the adsorption process. The DFT results will provide critical data on the electronic structure, binding energies, and interaction mechanisms between PFAS and SAMCs, helping to explain the observed experimental trends.

Preliminary studies investigated how different metal atoms in SAMC on biochar support, along with their coordinated systems involving varying combinations of nitrogen types (pyridinic- and/or pyrrolic-Ns), significantly modify the electron distribution around the SAMC system. Depending on the N-type composition in the Zn—N₄ coordination system, the electron distribution around Zn²⁺ and its surrounding region could shift from negative to neutral or even positive.

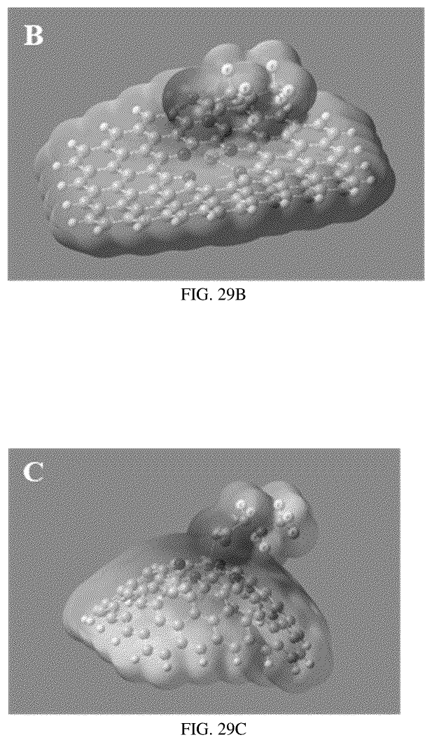

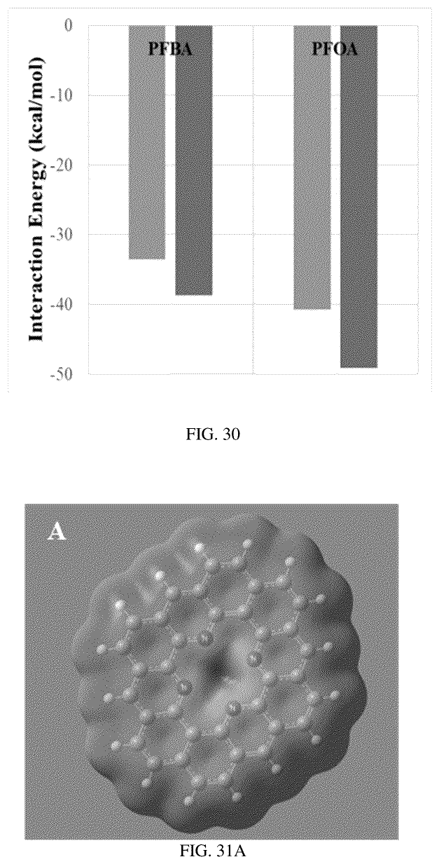

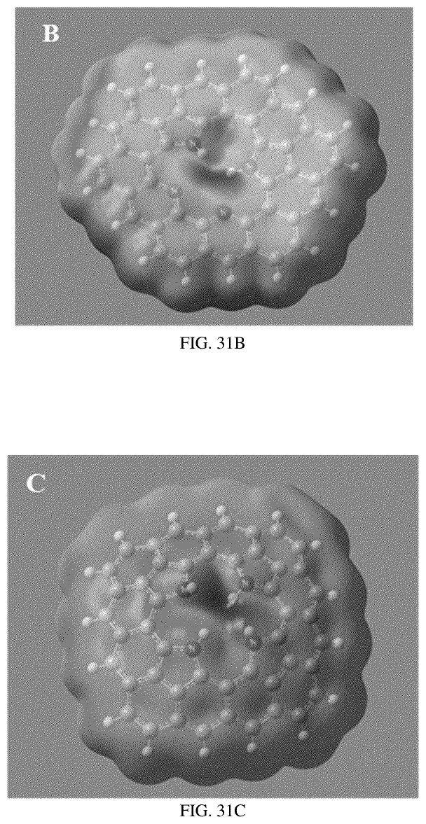

This alteration directly affects the adsorption of anionic PFBA, as demonstrated by the varying interaction energies of the systems shown in FIGS. 29A-29C, underscoring the fact that PFAS and PMS/PDS adsorption can be modulated by the composition of the SAMC. Furthermore, the investigation of the adsorption energies for different PFAS, comparing Zn²⁺ or Fe²⁺ single atom sites on biochar, revealed that biochar with Fe²⁺ showed comparatively higher adsorption, as indicated in FIG. 30, which is consistent with the experimental observation. In addition, the studies explored how different nitrogen compositions affect the charge distribution of the biochar layer before metal ion addition (FIGS. 31A-31C). The results indicated that pyridinic Ns resulted in a negative charge on the biochar surface, while pyrrolic Ns led to a positive charge on the biochar surface. Due to the importance of electrostatic interactions of PFAS with SAMC active sites, the results highlighted the importance of the structural composition of N bonded to the metal atoms when studying the role of metal atoms in PFAS adsorption to SAMCs.

The systematic approach for executing the DFT calculations will be used to gain critical molecular insights. For the analysis of different SAMCs, structures that exhibit higher PFAS adsorption capabilities will be prioritized, initiating calculations with those systems. The DFT study will encompass a range of SAMCs, including pristine biochar (as a control), biochar layers with single metal atoms sites, dual metal single atom sites, metal clusters (3-10 atoms), oxygen functionalized biochar with metal sites (realistic model) and without metal sites (as a control).

These DFT calculations will be performed using the Gaussian 16 Rev A.03, where Gaussian basis sets are applied with graphene model constrained with hydrogens to model the biochar surface. For example, Becke, 3-parameter, Lee-Yang Parr (B3LYP) exchange-correlation function with GENECP split basis set, where lanl2dz for transitional metals and 6-31G(d,p) for common elements, will be used for geometric optimization of SAMC systems. The system size will be optimized to ensure that interacting molecules experience a chemically consistent environment. All calculations will employ an implicit solvent model (SMD/water) to simulate the solvation effect, and the D3 version of Grimme's dispersion with Becke-Johnso damping function (GD3) will be included to accurately capture non-covalent interactions between molecules and the adsorbent surface.

Each system will undergo a comprehensive analysis, including geometric optimization, frequency calculations, energy calculations, and population analysis. The adsorption energy (Eads) associated with each molecular system will be calculated using the following equation:

$${E}_{a d s} = {E}_{system} - ( {E}_{P F A S} + {E}_{S A M C} )$$

where, E_{system}, E_{PFAS}, and E_{SAMC} are the energies of the whole molecular system, isolated PFAS or PMS/PDS molecule, and isolated adsorbent surface structure, respectively.

After completing the initial investigations of the model structure with Gaussian basis sets, further analysis of the SAMC system will be conducted with the inclusion of periodic boundary conditions in Quantum Espresso software, utilizing plane wave basis sets. This advanced evaluation will consider the impact of single metal atom incorporation on PFAS adsorption. Additionally, a more realistic biochar model, developed based on its chemical composition, will be introduced to assess the synergistic effects of various metal atoms and supporting materials on PFAS and PMS/PDS adsorption, as well as their catalytic performance.

A series of DFT calculations will be performed to evaluate the adsorption of PMS/PDS and their potential initiation of PFAS degradation after activation. The investigation will focus on identifying potential reaction sites and transition states and constructing potential energy profiles to elucidate the degradation mechanisms. Additionally, charge transfer and molecular orbital analysis will be performed to evaluate the behavior and reactivity of these radical precursors. Given the complexity and computational intensity of transition state calculations that will be considered through DFT calculations only, efforts will initially be focused on systems with the best-performing adsorbent surfaces, such as those incorporating iron single-atom sites, and systematically expand the analysis to include other adsorbents.

### Molecular Dynamics Simulations

Given the computational intensity of accounting for all relevant parameters (anions, cations, water, and NOMs) in PFAS-contaminated solutions, Molecular dynamics (MD) and Monte Carlo (MC) simulations are invaluable tools for addressing these complexities. In this study, the aim will be to analyze not only the adsorption behavior of PFAS on SAMCs in natural water environments at different pH levels but also the dynamics (necessitating MD simulations) of this process. Specifically, PFAS diffusion in solution, the residence time of PFAS molecules after adsorbing on SAMC surfaces, and the dynamics of the solvation shell around each PFAS molecule will be calculated using the all-atom molecular dynamics (AA-MD) technique.

The OPLS-AA (Optimized Potentials for Liquid Simulations) force field will serve as the primary empirical tool to calculate atomistic interactions in the system. OPLS-AA has previously proven effective in simulating PFAS adsorption on surfaces, providing a reliable basis for this study.

The MD simulations are divided into three key components. (1) PFAS in Bulk Solution: investigate the structure and dynamics of PFAS molecules in a bulk solution, focusing on their behavior at different concentrations. (2) PFAS Adsorption on SAMCs: focus on PFAS adsorption on SAMC surfaces, both with and without oxygen-containing functional groups on biochar support. (3) PFAS Adsorption on Metal-Modified Biochar: investigate the adsorption of PFAS on biochar surfaces containing various metal single atoms.

These investigations will be done as a function of PFAS concentration in the solution, from dilute to semi-dilute concentrations. The potential formation of micelles in solution and on SAMC surfaces will be observed. The first two investigations will be carried out using existing force field parameters for PFAS and oxygen-functionalized graphene (since the structure of biochar resembles graphene except for the functionalization of the surface). The third part of the investigation will first involve developing force field parameters for metal-containing biochar surfaces. The force field parameters will be developed from DFT calculations. The SPC/E water model, which is known to reproduce the structure and dynamic properties of water well in bulk and at surfaces and interfaces, will be used in modeling water. All the MD simulations will be done using LAMMPS open software.

Additionally, Umbrella Sampling will be applied to perform Potential Mean Force (PMF) calculations between PFAS-PFAS and PFAS-SAMC systems. This method will allow for the examination of the free energy of interactions as a function of separation distance with varying solution compositions.

These simulations will provide a detailed molecular-level understanding of PFAS behavior in bulk water, as well as their adsorption on different SAMCs supported by biochar. The resulting insights will be critical for optimizing PFAS removal under a wide range of environmental conditions and could further inform the design of other remediation technologies for contaminant removal.

1. A method of removing a contaminant from an aqueous medium, the method comprising contacting a contaminant with a single-atom metal catalyst on a carbonaceous support.

2. The method of claim 1, wherein the carbonaceous support is activated carbon or biochar.

3. The method of claim 1, wherein the single-atom catalyst comprises a metal atom (M) selected from the group consisting of zinc (Zn), copper (Cu), iron (Fe), cobalt (Co), nickel (Ni), palladium (Pd), aluminum (Al), and any combination thereof.

4. The method of claim 3, wherein the metal atom is coordinated to 2, 3, 4, or 5 heteroatoms of the carbonaceous support, and wherein each heteroatom is independently selected from the group consisting of nitrogen, oxygen, sulfur, and phosphorus.

5. The method of claim 3, wherein the single-atom catalyst on carbonaceous support comprises about 0.01 wt % to about 5 wt % metal.

6. The method of claim 1, further comprising adding the single-atom catalyst to the aqueous medium at a concentration of about 0.01 g/L to about 10 g/L.

7. The method of claim 1, further comprising contacting the contaminant, the single-atom metal catalyst, or a combination thereof with an oxidant.

8. The method of claim 1, wherein the step of contacting comprises oxidizing the contaminant.

9. The method of claim 8, wherein the oxidizing is a direct oxidation reaction, a radical oxidation reaction, or a combination thereof.

10. The method of claim 1, wherein the contaminant is a pharmaceutical contaminant, an environmental contaminant, or a combination thereof.

11. The method of claim 10, wherein the contaminant is a pharmaceutical contaminant comprising an antibiotic, a hormone, an opiate, an anti-inflammatory, or any combination thereof.

12. The method of claim 10, wherein the contaminant is an environmental contaminant that comprises a per- and polyfluoroalkyl substance (PFAS).

13. A method of preparing a single-atom zinc catalyst on a carbonaceous support, the method comprising:
combining a carbonaceous support source, dicyandiamide, and a metal salt in an aqueous solution to provide a mixture; and
pyrolyzing the mixture to provide the single-atom catalyst on the carbonaceous support.

14. The method of claim 13, wherein the carbonaceous support is activated carbon, biochar, or a combination thereof.

15. The method of claim 14, wherein the metal salt comprises a metal selected from the group consisting of zinc (Zn), copper (Cu), iron (Fe), cobalt (Co), nickel (Ni), palladium (Pd), and aluminum (Al), and an anion.

16. The method of claim 15, wherein the anion is selected from the group consisting of nitrate, acetate, sulfate, chlorate, phosphate, chloride, and bromide.

17. The method of claim 13, wherein the single-atom catalyst on carbonaceous support comprises about 0.01 wt % to about 5 wt % metal.

18. The method of claim 13, wherein the step of pyrolyzing comprises heating the mixture to a temperature of about 400° C. to about 1000° C.

19. The method of claim 13, further comprising a step of washing the single-atom zinc catalyst on a biochar support with an aqueous solution, thereby removing an impurity.

20. The method of claim 19, wherein the impurity comprises a metal oxide.
